(19) United States
(12) Patent Application Publication
(10) Pub. No.: US 2026/0141038 A1
(43) Pub. Date: May 21, 2026

(54) SYSTEMS AND METHODS OF SELECTIVE IMAGE FRAME MODIFICATION

(71) Applicant: QUALCOMM Incorporated, San Diego, CA (US)

(72) Inventors: Scott Benjamin LEASK, San Diego, CA (US); Khalid TAHBOUB, San Diego, CA (US); Junmin WU, San Diego, CA (US); Kai WANG, San Diego, CA (US)

(21) Appl. No.: 18/950,650

(22) Filed: Nov. 18, 2024

(51) Int. Cl. G06F 21/10; G06F 3/04842; G06V 40/16

(52) U.S. Cl. CPC G06F 21/1062; G06F 3/04842; G06V 40/16

(57) ABSTRACT

A sender device includes a memory configured to store an image frame of a video. The device also includes one or more processors coupled to the memory and configured to obtain encoded image data representing the image frame. The one or more processors are also configured to send, to a recipient device, a bitstream including the encoded image data as part of the video communication and a modification indicator that indicates whether image modification is sender permitted or sender prohibited at the recipient device.

### I. FIELD

The present disclosure is generally related to image frame modification.

### II. DESCRIPTION OF RELATED ART

Advances in technology have resulted in smaller and more powerful computing devices. For example, there currently exist a variety of portable personal computing devices, including wireless telephones such as mobile and smart phones, tablets and laptop computers that are small, lightweight, and easily carried by users. These devices can communicate voice and data packets over wireless networks. Further, many such devices incorporate additional functionality such as a digital still camera, a digital video camera, a digital recorder, and an audio file player. Also, such devices can process executable instructions, including software applications, such as a web browser application, that can be used to access the Internet. As such, these devices can include significant computing capabilities.

Such computing devices often incorporate functionality for online conferencing or other forms of video communication. Sometimes, however, video communication can seem unnatural due to diversions from in-person interaction. For example, varying head poses and eye gaze angles relative to different camera locations can result in a perceived lack of eye contact with a remote participant in a video call. Filters can be applied to modify one or more features of video data, such as adjusting an eye gaze direction of a person in a video call to appear more natural to a recipient during the call. However, such filters are typically applied unilaterally without consent or knowledge of the other party. For example, a sender applies a filter without recipient knowledge, or a recipient applies a filter without sender consent. Encoding can distort original image information, resulting in lower quality modifications at the recipient or the recipient not receiving original image data because the sender performed modifications prior to encoding.

### III. SUMMARY

According to one implementation of the present disclosure, a sender device includes a memory configured to store an image frame of a video. The sender device also includes one or more processors coupled to the memory and configured to obtain encoded image data representing the image frame. The one or more processors are also configured to send, to a recipient device during a video communication between the sender device and the recipient device, a bitstream including the encoded image data as part of the video communication and a modification indicator that indicates whether image modification is sender permitted or sender prohibited at the recipient device.

According to another implementation of the present disclosure, a method includes obtaining, at a sender device, encoded image data representing an image frame of a video. The method also includes sending, from the sender device to a recipient device during a video communication between the sender device and the recipient device, a bitstream including the encoded image data as part of the video communication and a modification indicator that indicates whether image modification is sender permitted or sender prohibited at the recipient device.

According to one implementation of the present disclosure, a non-transitory computer-readable medium stores instructions that, when executed by one or more processors, cause the one or more processors to obtain, at a sender device, encoded image data representing an image frame of a video. The instructions also cause the one or more processors to send, from the sender device to a recipient device during a video communication between the sender device and the recipient device, a bitstream including the encoded image data as part of the video communication and a modification indicator that indicates whether image modification is sender permitted or sender prohibited at the recipient device.

According to another implementation of the present disclosure, an apparatus includes means for obtaining encoded image data representing an image frame of a video. The apparatus also includes means for transmitting a bitstream from a sender device to a recipient device during a video communication between the sender device and the recipient device, the bitstream including the encoded image data as part of the video communication and a modification indicator that indicates whether image modification is sender permitted or sender prohibited at the recipient device.

According to another implementation of the present disclosure, a recipient device includes a memory configured to store encoded image data that represents an image frame of a video. The device also includes one or more processors coupled to the memory and configured to obtain a modification indicator that indicates whether image modification is sender permitted or sender prohibited, the modification indicator obtained from a bitstream received from a sender device during a video communication between the sender device and the recipient device. The bitstream also includes the encoded image data as part of the video communication. The one or more processors are also configured to selectively generate a modified image frame at least partially based on whether the image modification is sender permitted or sender prohibited, the modified image frame at least partially based on the encoded image data.

According to another implementation of the present disclosure, a method includes obtaining, at a recipient device, a modification indicator that indicates whether image modification is sender permitted or sender prohibited, the modification indicator obtained from a bitstream received from a sender device during a video communication between the sender device and the recipient device. The bitstream also includes encoded image data representing an image frame as part of the video communication. The method also includes selectively generating, at the device, a modified image frame at least partially based on whether the image modification is sender permitted or sender prohibited, the modified image frame at least partially based on the encoded image data.

According to another implementation of the present disclosure, a non-transitory computer-readable medium stores instructions that, when executed by one or more processors, cause the one or more processors to obtain, at a recipient device, a modification indicator that indicates whether image modification is sender permitted or sender prohibited, the modification indicator obtained from a bitstream received from a sender device during a video communication between the sender device and the recipient device. The bitstream also includes the encoded image data as part of the video communication. The instructions also cause the one or more processors to selectively generate a modified image frame at least partially based on whether the image modification is sender permitted or sender prohibited, the modified image frame at least partially based on the encoded image data.

According to another implementation of the present disclosure, an apparatus includes means for obtaining, at a recipient device, a modification indicator that indicates whether image modification is sender permitted or sender prohibited, the modification indicator obtained from a bitstream received from a sender device during a video communication between the sender device and the recipient device. The bitstream also includes encoded image data representing an image frame as part of the video communication. The apparatus also includes means for selectively generating a modified image frame at least partially based on whether the image modification is sender permitted or sender prohibited, the modified image frame at least partially based on the encoded image data.

Other aspects, advantages, and features of the present disclosure will become apparent after review of the entire application, including the following sections: Brief Description of the Drawings, Detailed Description, and the Claims.

### IV. BRIEF DESCRIPTION OF THE DRAWINGS

FIG. 1 is a block diagram of a particular illustrative aspect of a system operable to perform selective image frame modification, in accordance with some examples of the present disclosure.

FIG. 2 is a diagram of another illustrative aspect of a system operable to perform selective image frame modification, in accordance with some examples of the present disclosure.

FIG. 3 is a diagram of an illustrative aspect of operations associated with a modification manager of the system of FIG. 1 or FIG. 2, in accordance with some examples of the present disclosure.

FIG. 4 illustrates an example of an integrated circuit operable to perform selective image frame modification, in accordance with some examples of the present disclosure.

FIG. 5 is a diagram of a mobile device operable to perform selective image frame modification, in accordance with some examples of the present disclosure.

FIG. 6 is a diagram of a wearable electronic device operable to perform selective image frame modification, in accordance with some examples of the present disclosure.

FIG. 7 is a diagram of a mixed reality or augmented reality glasses device operable to perform selective image frame modification, in accordance with some examples of the present disclosure.

FIG. 8 is a diagram of a voice-controlled speaker system operable to perform selective image frame modification, in accordance with some examples of the present disclosure.

FIG. 9 is a diagram of a camera operable to perform selective image frame modification, in accordance with some examples of the present disclosure.

FIG. 10 is a diagram of a headset, such as a virtual reality, mixed reality, or augmented reality headset, operable to perform selective image frame modification, in accordance with some examples of the present disclosure.

FIG. 11 is a diagram of a first example of a vehicle operable to perform selective image frame modification, in accordance with some examples of the present disclosure.

FIG. 12 is a diagram of a second example of a vehicle operable to perform selective image frame modification, in accordance with some examples of the present disclosure.

FIG. 13 is a diagram of a particular implementation of a method of performing selective image frame modification that may be performed by the system of FIG. 1 or FIG. 2, in accordance with some examples of the present disclosure.

FIG. 14 is a diagram of a particular implementation of another method of performing selective image frame modification that may be performed by the system of FIG. 1 or FIG. 2, in accordance with some examples of the present disclosure.

FIG. 15 is a block diagram of a particular illustrative example of a device that is operable to perform selective image frame modification, in accordance with some examples of the present disclosure.

### V. DETAILED DESCRIPTION

Typically, video communication can seem unnatural due to varying head poses and eye gaze angles relative to different camera locations. Filters can be applied unilaterally to modify one or more features of video data without consent or knowledge of the other party. Encoding of the video data for transmission between a sender and a recipient can distort original image information, resulting in limited (e.g., simple) or lower quality modifications at the recipient or the recipient not receiving original image data because the sender performed modifications prior to encoding. The recipient does not have any control over which modifications are performed at the sender and may be unaware that the content has been modified by the sender. The sender might not be comfortable with modifications performed by the recipient without consent from the sender.

Systems and methods of performing selective image frame modification are disclosed. For example, a sender user of a sender device sends video data, such as streaming video, for playback to a recipient user of a recipient device. According to an aspect of the disclosed techniques, the sender device includes a sender modification manager, and the recipient device includes a recipient modification manager.

In an example, the sender user provides a user input to the sender device indicating that a first modification feature (e.g., eye gaze correction) is permitted at the recipient device and that a second modification feature (e.g., a beauty filter) is prohibited at the recipient device for the streaming video. Similarly, in some examples, the recipient user provides a user input to the recipient device indicating that the first modification feature (e.g., eye gaze correction) and the second modification feature (e.g., a beauty filter) are both permitted at the recipient device for playback of the streaming video.

The sender device encodes an input image frame of the streaming video to generate encoded image data. The sender device sends, in a bitstream, the encoded image data, a modification indicator indicating that image modification is sender permitted, a first sender permitted feature indicator indicating that the first modification feature (e.g., eye gaze correction) is sender permitted, and a second sender permitted feature indicator indicating that the second modification feature (e.g., a beauty filter) is sender prohibited at the recipient device for the encoded image data.

The recipient modification manager processes the encoded image data to generate a decoded image frame of the streaming video. In some examples, the recipient modification manager, based on determining that each of the first sender permitted feature indicator and a first recipient permitted feature indicator indicates that the first modification feature (e.g., eye gaze correction) is permitted, determines that the first modification feature (e.g., eye gaze correction) is permitted. Alternatively, in some other examples, the recipient modification manager, based on determining that the first sender permitted feature indicator indicates that the first modification feature (e.g., eye gaze correction) is permitted and independently of a first recipient permitted feature indicator, determines that the first modification feature (e.g., eye gaze correction) is permitted. The recipient modification manager, in response to determining that the permitted modification feature is performable on the decoded image frame, generates an output image frame that is based on applying the first modification feature to the decoded image frame. The recipient modification manager, based on determining that the second sender permitted feature indicator indicates that the second modification feature (e.g., a beauty filter) is sender prohibited, determines that the second modification feature is prohibited and refrains from performing the second modification feature when generating the output image frame.

A technical advantage includes enabling selective performance of the modification features to generate the output image frame that are permitted by the sender user and, optionally the recipient user in some examples. Optionally, in some examples, the sender modification manager additionally sends sender modification data (e.g., facial landmark data) that can facilitate applying a sender permitted modification feature (e.g., eye gaze correction) at the recipient device. An output image frame based on sender modification data that is generated from the original input image frame can have higher quality (e.g., fewer artifacts, more complex modifications, etc.) as compared to an output image frame based on recipient modification data that is generated from the decoded image frame.

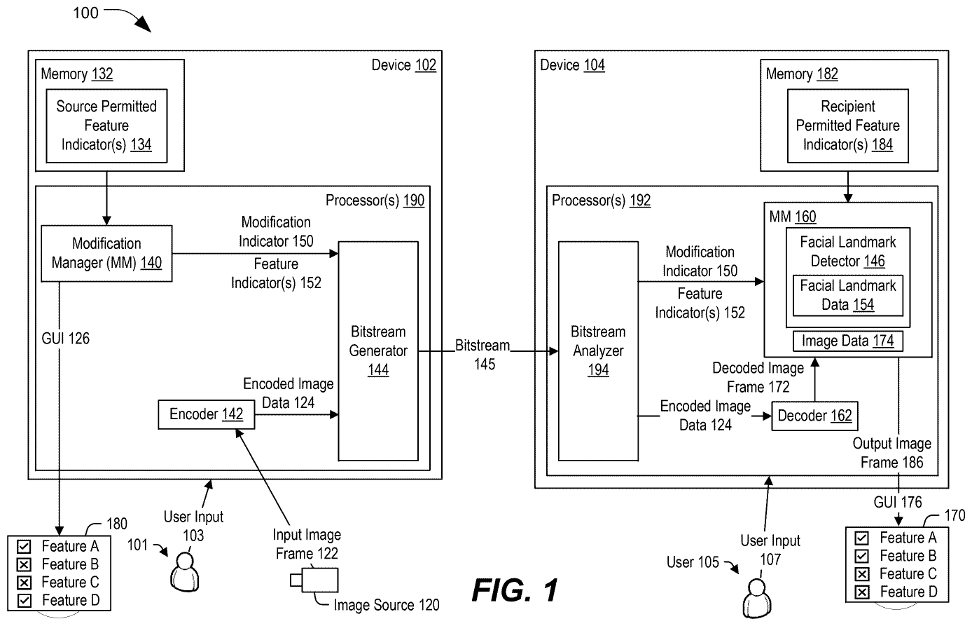

Particular aspects of the present disclosure are described below with reference to the drawings. In the description, common features are designated by common reference numbers. As used herein, various terminology is used for the purpose of describing particular implementations only and is not intended to be limiting of implementations. For example, the singular forms “a,” “an,” and “the” are intended to include the plural forms as well, unless the context clearly indicates otherwise. Further, some features described herein are singular in some implementations and plural in other implementations. To illustrate, FIG. 1 depicts a device 102 including one or more processors (“processor(s)” 190 of FIG. 1), which indicates that in some implementations the device 102 includes a single processor 190 and in other implementations the device 102 includes multiple processors 190. For ease of reference herein, such features are generally introduced as “one or more” features and are subsequently referred to in the singular or optional plural (as indicated by “(s)”) unless aspects related to multiple of the features are being described.

As used herein, the terms “comprise,” “comprises,” and “comprising” may be used interchangeably with “include,” “includes,” or “including.” Additionally, the term “wherein” may be used interchangeably with “where.” As used herein, “exemplary” indicates an example, an implementation, and/or an aspect, and should not be construed as limiting or as indicating a preference or a preferred implementation. As used herein, an ordinal term (e.g., “first,” “second,” “third,” etc.) used to modify an element, such as a structure, a component, an operation, etc., does not by itself indicate any priority or order of the element with respect to another element, but rather merely distinguishes the element from another element having a same name (but for use of the ordinal term). As used herein, the term “set” refers to one or more of a particular element, and the term “plurality” refers to multiple (e.g., two or more) of a particular element.

As used herein, “coupled” may include “communicatively coupled,” “electrically coupled,” or “physically coupled,” and may also (or alternatively) include any combinations thereof. Two devices (or components) may be coupled (e.g., communicatively coupled, electrically coupled, or physically coupled) directly or indirectly via one or more other devices, components, wires, buses, networks (e.g., a wired network, a wireless network, or a combination thereof), etc. Two devices (or components) that are electrically coupled may be included in the same device or in different devices and may be connected via electronics, one or more connectors, or inductive coupling, as illustrative, non-limiting examples. In some implementations, two devices (or components) that are communicatively coupled, such as in electrical communication, may send and receive signals (e.g., digital signals or analog signals) directly or indirectly, via one or more wires, buses, networks, etc. As used herein, “directly coupled” may include two devices that are coupled (e.g., communicatively coupled, electrically coupled, or physically coupled) without intervening components.

In the present disclosure, terms such as “obtaining,” “determining,” “calculating,” “estimating,” “shifting,” “adjusting,” etc. may be used to describe how one or more operations are performed. It should be noted that such terms are not to be construed as limiting and other techniques may be utilized to perform similar operations. Additionally, as referred to herein, “obtaining,” “generating,” “calculating,” “estimating,” “using,” “selecting,” “accessing,” and “determining” may be used interchangeably. For example, “generating,” “calculating,” “estimating,” “obtaining,” or “determining” a parameter (or a signal) may refer to actively generating, estimating, calculating, or determining the parameter (or the signal) or may refer to using, selecting, receiving, or accessing the parameter (or signal) that is already generated, such as by another component or device.

Referring to FIG. 1, a particular illustrative aspect of a system 100 configured to perform selective image frame modification is disclosed, in accordance with some examples of the present disclosure. The system 100 includes a device 102 that is configured to be communicatively coupled to a device 104.

In an example, the device 102 (e.g., a sender device) is configured to send video data, such as a streaming video obtained at the device 102 from an image source 120, to the device 104 (e.g., a recipient device). The device 104 is configured to process the video data received from the device 102 and selectively perform one or more modifications to generate modified video data that can be played back.

The image source 120 is depicted as a camera in FIG. 1 as an illustrative example; in other examples, the image source 120 can include a storage device, a network device, a video streaming source, a component (e.g., an image generation engine) of the device 102, one or more processors 190 of the device 102, or a combination thereof. The image source 120 is configured to output (e.g., generate) one or more image frames, such as a sequence of image frames of a video.

The device 102 includes the one or more processors 190 coupled to a memory 132. The one or more processors 190 are also coupled to the image source 120, and optionally to a display device 180. The image source 120 and the display device 180 are depicted as external to the device 102 as an illustrative example; in some other examples, the image source 120, the display device 180, or both, can be integrated into the device 102. The image source 120 is depicted as external to the one or more processors 190 as an illustrative example; in some other examples, the one or more processors 190 include the image source 120 (e.g., a gaming engine that generates video data). The processor(s) 190 include a modification manager (MM) 140, an encoder 142, and a bitstream generator 144.

The memory 132 is configured to store one or more source permitted feature indicators 134 that indicate whether one or more image modification features are source permitted. As an example, the one or more image modification features include eye gaze correction, beauty filter, character filter, background replacement, another type of image modification, or a combination thereof. To illustrate, a source permitted feature indicator 134 has a first value (e.g., 1) to indicate that a corresponding modification feature (e.g., eye gaze correction) is source permitted. Alternatively, the source permitted feature indicator 134 has a second value (e.g., 0) to indicate that the corresponding modification feature (e.g., eye gaze correction) is source prohibited. In some aspects, the source permitted feature indicator(s) 134 are based on a configuration setting, default data, a user input 103 from a user 101 (e.g., a sender user), an input (e.g., metadata associated with the image data) from the image source 120, or a combination thereof.

The encoder 142 is configured to encode an input image frame 122 obtained from the image source 120 to generate encoded image data 124. The MM 140 is configured to generate a modification indicator 150, one or more feature indicators 152, or a combination thereof, corresponding to the input image frame 122. The modification indicator 150 indicates whether image modification at the device 104 is permitted or prohibited by a sender (e.g., the user 101, the image source 120, the device 102, or a combination thereof) of the input image frame 122. A feature indicator 152 indicates whether a corresponding image modification feature is permitted or prohibited at a recipient device (e.g., the device 104) by the sender of the input image frame 122. To illustrate, in some examples, when a source permitted feature indicator 134 has a first value (e.g., 1) to indicate that a corresponding modification feature (e.g., eye gaze correction) is source permitted, a feature indicator 152 has a first value (e.g., 1) to indicate that the corresponding modification feature (e.g., eye gaze correction) is sender permitted at the recipient device. Alternatively, when the source permitted feature indicator 134 has a second value (e.g., 0) to indicate that the corresponding modification feature (e.g., eye gaze correction) is source prohibited, the feature indicator 152 has a second value (e.g., 0) to indicate that the corresponding modification feature (e.g., eye gaze correction) is sender prohibited at the recipient device. The bitstream generator 144 is configured to generate a bitstream 145 including the encoded image data 124 and optionally including the modification indicator 150, the feature indicator(s) 152, or a combination thereof. The device 102 is configured to provide the bitstream 145 to the device 104.

The memory 132 is also configured to store data used or generated by the image source 120, the modification manager 140, the encoder 142, the bitstream generator 144, or a combination thereof. For example, the memory 132 is configured to store the input image frame 122, the encoded image data 124, the modification indicator 150, the one or more feature indicators 152, or a combination thereof.

The device 104 includes one or more processors 192 coupled to a memory 182 and optionally coupled to a display device 170. The display device 170 is depicted as external to the device 104 as an illustrative example; in some other examples, the display device 170 can be integrated into the device 104. The processor(s) 192 include a bitstream analyzer 194, a modification manager 160, and a decoder 162.

The memory 182 is configured to store one or more recipient permitted feature indicators 184 that indicate whether one or more image modification features are recipient permitted. To illustrate, a recipient permitted feature indicator 184 has a first value (e.g., 1) to indicate that a corresponding modification feature (e.g., eye gaze correction) is recipient permitted. Alternatively, the recipient permitted feature indicator 184 has a second value (e.g., 0) to indicate that the corresponding modification feature (e.g., eye gaze correction) is recipient prohibited. In some aspects, the recipient permitted feature indicator(s) 184 are based on a configuration setting, default data, a user input 107 from a user 105, or a combination thereof.

Optionally, in some embodiments, the modification manager 160 includes a facial landmark detector 146. The facial landmark detector 146 integrated in the modification manager 160 is provided as an illustrative example; in some other examples the facial landmark detector 146 can be external to the modification manager 160, external to the device 104, or both. It should be understood that the facial landmark detector 146 is provided as an illustrative example of a modification data generator that is configured to generate modification data that can be used to facilitate application of a corresponding image modification, and in some other examples the modification manager 160 can include one or more other types of modification data generators in addition to or as an alternative to the facial landmark detector 146.

The device 104 is configured to receive the bitstream 145 from the device 102. The bitstream analyzer 194 is configured to obtain the encoded image data 124 and optionally the modification indicator 150, the feature indicator(s) 152, or a combination thereof, from the received bitstream 145. The decoder 162 is configured to decode the encoded image data 124 to generate a decoded image frame 172.

The modification manager 160 is configured to, in response to receiving the decoded image frame 172, determine whether a modification feature is permitted (e.g., sender permitted and recipient permitted) based on the modification indicator 150, the feature indicator(s) 152, the recipient permitted feature indicator(s) 184, or a combination thereof. The modification manager 160 is configured to, in response to determining that a modification feature is permitted, determine whether the image modification is performable on the decoded image frame 172.

Optionally, in some embodiments, the facial landmark detector 146 is configured to, based on determining that at least one modification feature is permitted, selectively perform facial landmark detection on the decoded image frame 172 to generate facial landmark data 154. In a particular aspect, the facial landmark data 154 corresponds to a lightweight facial representation. For example, the facial landmark data 154 indicates locations (e.g., pixel coordinates) of facial landmarks (e.g., corners of the eyes, tip of the nose, edges of the mouth, contours of a face, etc.) detected in the decoded image frame 172. In an embodiment, in response to determining that the facial landmark data 154 (e.g., indicating detected eyes) corresponds to a permitted modification feature (e.g., gaze correction), the modification manager 160 is configured to determine that the permitted modification feature is performable on the decoded image frame 172. Similarly, one or more other modification data generators may be configured to determine whether other corresponding modification features are performable on the decoded image frame 172.

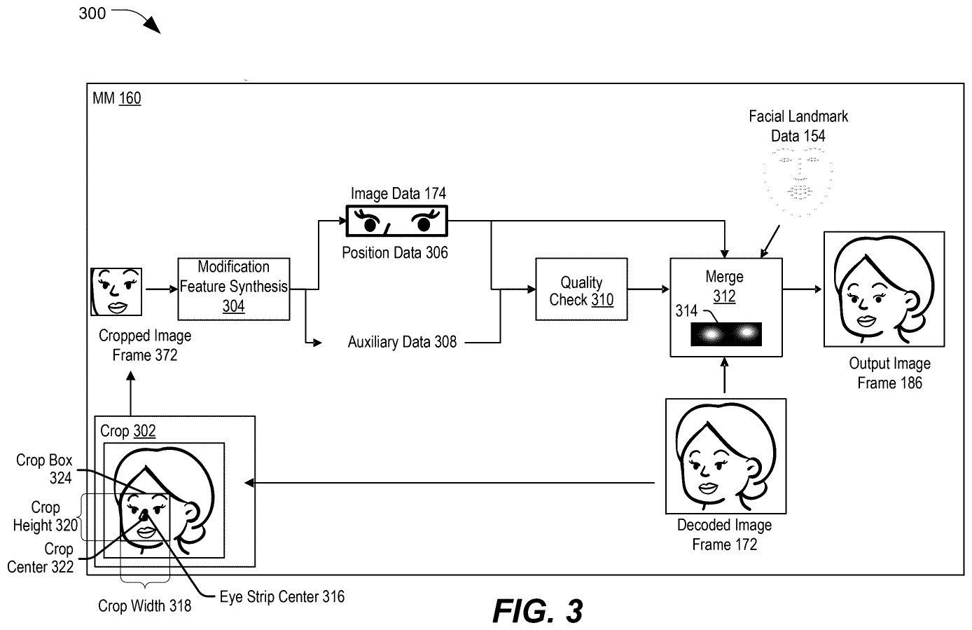

The modification manager 160 is configured to selectively perform one or more permitted modification features that are performable on the decoded image frame 172 to generate image data 174 (e.g., additional image data) and combine the decoded image frame 172 and the image data 174 to generate an output image frame 186 (e.g., a modified image frame), as further described with reference to FIG. 3. In an example, the output image frame 186 corresponds to a copy of the decoded image frame 172 with a portion of the decoded image frame 172 replaced with the image data 174 in the output image frame 186.

According to an aspect, in addition to the recipient permitted feature indicator(s) 184, the memory 182 is also configured to store data used or generated by the modification manager 160, the decoder 162, the bitstream analyzer 194, or a combination thereof. For example, the memory 182 is configured to store the encoded image data 124, the decoded image frame 172, the modification indicator 150, the one or more feature indicators 152, the facial landmark data 154, other type of modification data, the image data 174, the output image frame 186, or a combination thereof.

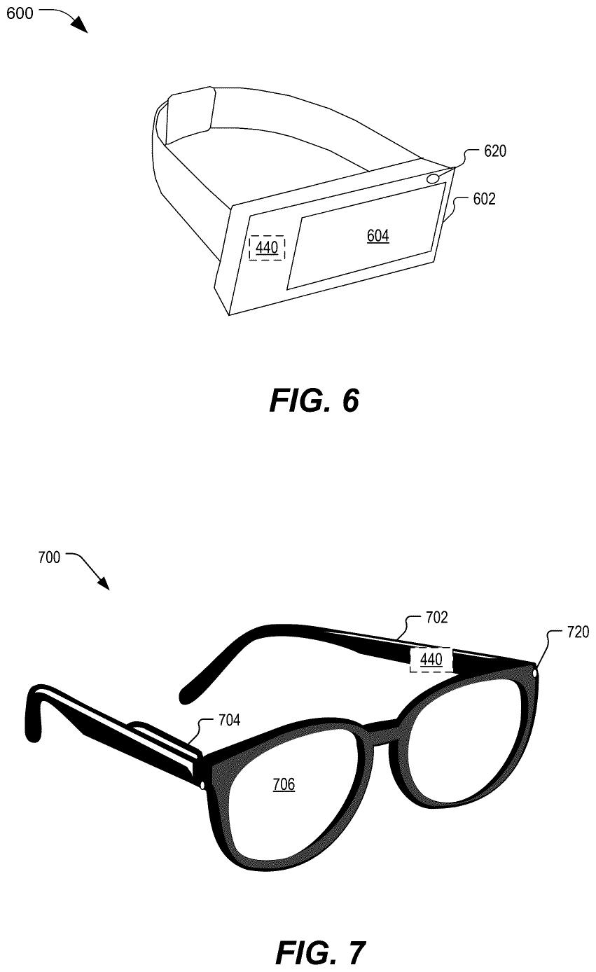

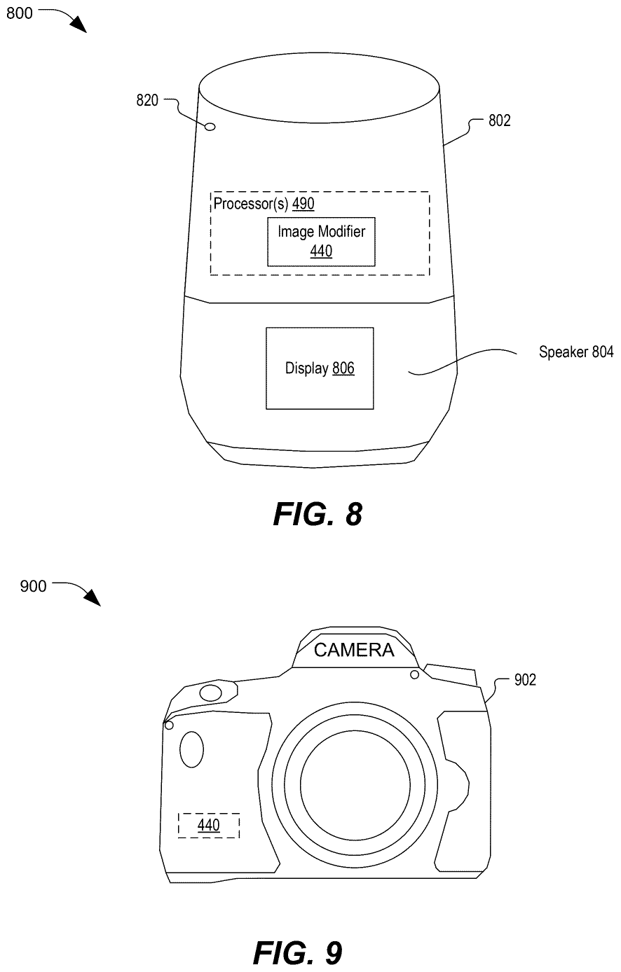

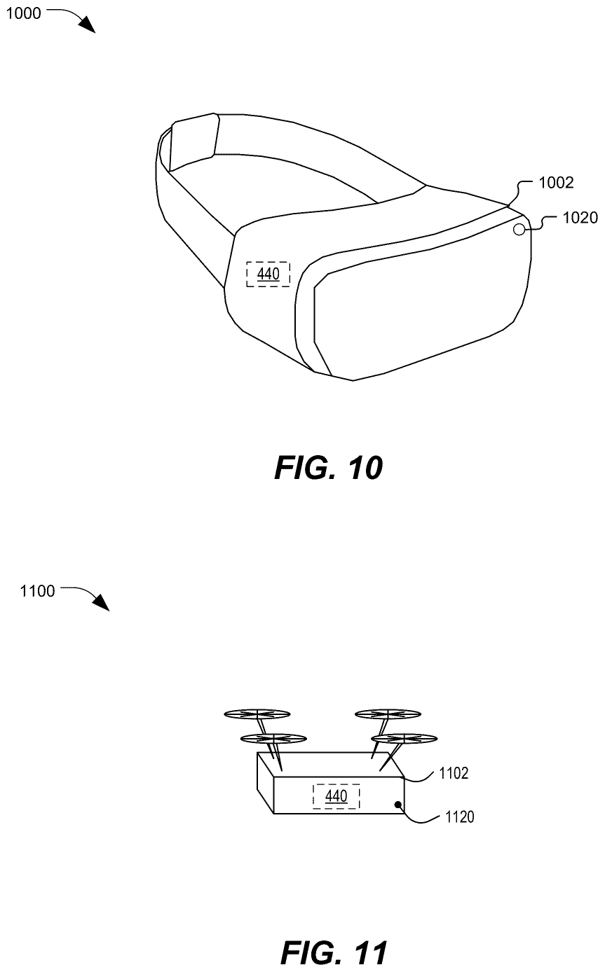

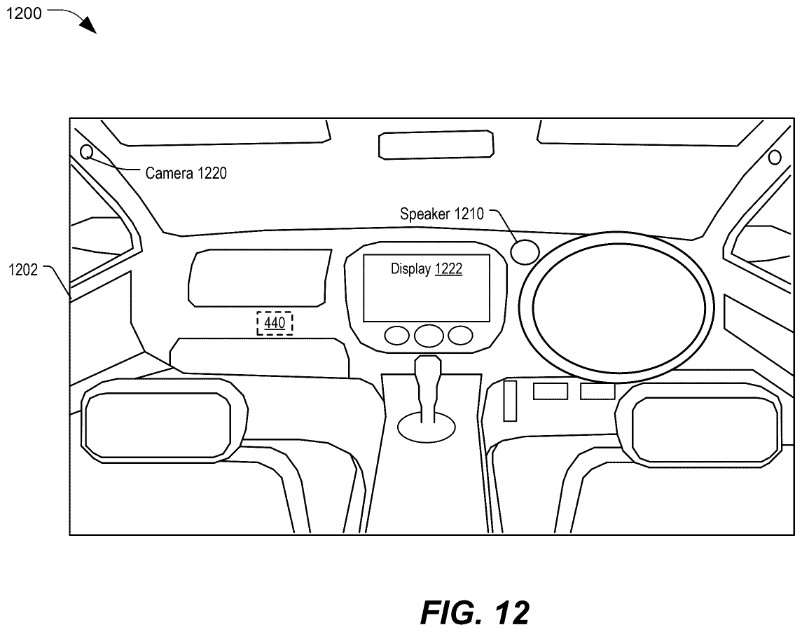

In some embodiments, the device 102, the device 104, or both, correspond to or are included in one of various types of devices. In an illustrative example, the one or more processors 190 are integrated in at least one of a mobile phone or a tablet computer device, as described with reference to FIG. 5, a wearable electronic device, as described with reference to FIG. 6, a mixed reality or augmented reality glasses device, as described with reference to FIG. 7, a voice-controlled speaker system, as described with reference to FIG. 8, a camera device, as described with reference to FIG. 9, or a virtual reality, mixed reality, or augmented reality headset, as described with reference to FIG. 10. In another illustrative example, the one or more processors 190 are integrated into a vehicle, such as described further with reference to FIG. 11 and FIG. 12.

During operation, the modification manager 140 of the device 102 (e.g., a sender device) can provide a graphical user interface (GUI) 126 to the display device 180. The display device 180 is configured to display the GUI 126. In some examples, the modification manager 140 provides the GUI 126 to the display device 180 prior to or during a video communication session between the device 102 and the device 104. The GUI 126 includes one or more user selectable options corresponding to a first set of image modification features (e.g., a modification feature A, a modification feature B, a modification feature C, a modification feature D, one or more additional modification features, or a combination thereof). A user 101 provides a user input 103 indicating which of the first set of image modification features are permitted or prohibited by the user 101 for image data to be sent from the device 102 to one or more recipient devices (e.g., the device 104).

The modification manager 140, based on the user input 103, determines (e.g., updates or generates) the one or more source permitted feature indicators 134. For example, the modification manager 140, in response to determining that the user input 103 indicates that the modification feature A is permitted, generates a first source permitted feature indicator 134 having a first value (e.g., 1) indicating that the corresponding modification feature A is source permitted. As another example, the modification manager 140, in response to determining that the user input 103 indicates that the modification feature B is prohibited, generates a second source permitted feature indicator 134 having a second value (e.g., 0) indicating that the corresponding modification feature B is source prohibited. The modification manager 140 stores the one or more source permitted feature indicators 134 in the memory 132. It should be understood that a source permitted feature indicator 134 having a value based on the user input 103 is provided as an illustrative example, and in some other examples the value of the source permitted feature indicator 134 can be based on default data, a configuration setting, an input from the image source 120, or a combination thereof.

Similarly, at the device 104 (e.g., a recipient device), the modification manager 160 can provide a GUI 176 to the display device 170. The display device 170 is configured to display the GUI 176. In some examples, the modification manager 160 provides the GUI 176 to the display device 170 prior to or during the video communication session between the device 102 and the device 104. The GUI 176 includes one or more user selectable options corresponding to a second set of image modification features (e.g., the modification feature A, the modification feature B, the modification feature C, the modification feature D, one or more additional modification features, or a combination thereof). Although the display device 170 is depicted as displaying selectable options corresponding to the same modification features as the selectable options displayed by the display device 180, in some other examples the second set of image modification features can include fewer modification features, more modification features, or different modification features than are included in the first set of image modification features. A user 105 provides a user input 107 indicating which of the second set of image modification features are permitted or prohibited by the user 105 for image data received at the device 104 from one or more sender devices (e.g., the device 102).

The modification manager 160, based on the user input 107, determines (e.g., updates or generates) the one or more recipient permitted feature indicators 184. For example, the modification manager 160, in response to determining that the user input 107 indicates that the modification feature A is recipient permitted, generates a first recipient permitted feature indicator 184 having a first value (e.g., 1) indicating that the corresponding modification feature A is recipient permitted. As another example, the modification manager 160, in response to determining that the user input 107 indicates that the modification feature C is prohibited, generates a second recipient permitted feature indicator 184 having a second value (e.g., 0) indicating that the corresponding modification feature C is recipient prohibited. The modification manager 160 stores the one or more recipient permitted feature indicators 184 in the memory 182. It should be understood that a recipient permitted feature indicator 184 having a value based on the user input 107 is provided as an illustrative example, and in some other examples the value of the recipient permitted feature indicator 184 can be based on default data, a configuration setting, or both.

At the sender device, the modification manager 140 generates a modification indicator 150 based on the one or more source permitted feature indicators 134. The modification indicator 150 indicates whether any image modification is sender permitted. For example, if any of the one or more source permitted feature indicators 134 indicate a source permitted modification feature, the modification indicator 150 has a first value (e.g., 1) indicating that image modification is sender permitted. Alternatively, if none of the source permitted feature indicator(s) 134 indicate a source permitted modification feature, the modification indicator 150 has a second value (e.g., 0) indicating that image modification is sender prohibited. The modification manager 140 provides the modification indicator 150 to the bitstream generator 144.

The modification manager 140 generates one or more feature indicators 152 based on the one or more source permitted feature indicators 134 and provides the one or more feature indicators 152 to the bitstream generator 144. Optionally, in some embodiments, the modification manager 140 selectively generates the one or more feature indicators 152. For example, the modification manager 140, based on determining that image modification is source permitted, provides the one or more source permitted feature indicators 134 as the one or more feature indicators 152 to the bitstream generator 144. Alternatively, the modification manager 140, based on determining that image modification is sender prohibited, refrains from providing the one or more feature indicators 152 to the bitstream generator 144 or provides a predetermined value (e.g., a null value) to the bitstream generator 144. In some aspects, the modification manager 140 provides the modification indicator 150, the one or more feature indicators 152, or a combination thereof, to the bitstream generator 144 prior to or during a video communication (e.g., a video streaming session) between the device 102 and the device 104.

During the video streaming session, the encoder 142 obtains encoded image data 124 representing an input image frame 122. For example, the encoder 142 obtains the input image frame 122 from the image source 120 and encodes the input image frame 122 to generate the encoded image data 124. The encoder 142 provides the encoded image data 124 to the bitstream generator 144. Optionally, in some embodiments, the encoder 142 provides the encoded image data 124 to the bitstream generator 144 concurrently with the modification manager 140 providing the modification indicator 150, the one or more feature indicators 152, or a combination thereof, corresponding to the input image frame 122 to the bitstream generator 144.

The bitstream generator 144 sends, to the device 104 during a video communication between the device 102 and the device 104, a bitstream 145 including the encoded image data 124 as part of the video communication and the modification indicator 150 that indicates whether image modification is sender permitted or sender prohibited at the device 104. In some embodiments, the bitstream generator 144 sends the modification indicator 150 at the initialization of a video stream transmission, when there is a change in the modification indicator 150 compared to the most recently sent value of the modification indicator 150, after sending encoded image data corresponding to a threshold count of image frames (e.g., 30 image frames or 60 image frames) since the most recently transmitted modification indicator 150, concurrently with encoded image data 124 of each input image frame 122, or a combination thereof.

Optionally, in some embodiments, the bitstream generator 144 also sends, in the bitstream 145, the one or more feature indicators 152 that indicate whether one or more modification features are sender permitted or sender prohibited at the device 104. For example, the bitstream generator 144, in response to determining that a source permitted feature indicator 134 indicates that a modification feature is source permitted, selectively sends a feature indicator 152 in the bitstream 145 indicating that the modification feature is sender permitted.

Optionally, in some embodiments, the bitstream generator 144 sends the one or more feature indicators 152 in the bitstream 145 independently of the value of the modification indicator 150. In other embodiments, the bitstream generator 144 selectively sends the one or more feature indicators 152 in the bitstream 145 based on determining that the modification indicator 150 has a first value (e.g., 1) indicating that image modification is sender permitted. Alternatively, when the modification indicator 150 has a second value (e.g., 0) indicating that image modification is sender prohibited, the bitstream generator 144 refrains from sending the one or more feature indicators 152 in the bitstream 145.

In some embodiments, the bitstream generator 144 sends the one or more feature indicators 152 in the bitstream 145 concurrently with sending the encoded image data 124 for every input image frame 122. In other embodiments, the bitstream generator 144 sends the one or more feature indicators 152 in the bitstream 145 based on determining that one or more flag update criteria are satisfied. For example, the bitstream generator 144 determines that a flag update criterion is satisfied in response to detecting a change in the one or more feature indicators 152 compared to most recently sent one or more feature indicators 152. In another example, the bitstream generator 144 determines that a flag update criterion is satisfied in response to determining that at least a threshold count of input image frames (e.g., 30 frames or 60 frames) between a previous input image frame 122 and the input image frame 122 have elapsed for which the one or more feature indicators 152 have not been sent in the bitstream 145. In some embodiments, the bitstream generator 144 determines that a flag update criterion is satisfied in response to determining that the input image frame 122 corresponds to (e.g., is encoded as) a particular frame type (e.g., a key frame, such as an intra frame (I-frame)).

The device 104 receives the bitstream 145 from the device 102 during the video communication between the device 102 and the device 104. The bitstream analyzer 194 obtains the encoded image data 124 as part of the video communication and optionally the modification indicator 150, the feature indicator(s) 152, or a combination thereof, from the received bitstream 145. In a particular embodiment, the encoded image data 124 and the modification indicator 150 are standard-compliant (e.g., included in a standard-compliant supplemental enhancement information (SEI) message) and the one or more feature indicators 152 are included as additional non-standard flags. In this embodiment, the modification indicator 150 also corresponds to an indicator of whether the additional non-standard flags are present in the bitstream 145. For example, the SEI message may include one or more fields that are in compliance with a defined communication protocol specification, such as published by an industry consortium. Sending the encoded image data 124 and the modification indicator 150 in the standard-compliant SEI message can ensure interoperability between devices that implement the communication protocol.

In an example, the bitstream analyzer 194, in response to determining that the modification indicator 150 has a first value (e.g., 0) indicating that image modification is sender prohibited and that additional non-standard flags are not present, refrains from parsing the bitstream 145 to extract the one or more feature indicators 152. Alternatively, when the modification indicator 150 has a second value (e.g., 1) indicating that image modification is sender permitted and that additional non-standard flags are present, the bitstream analyzer 194 parses the bitstream 145 to extract the one or more feature indicators 152.

The bitstream analyzer 194 provides the modification indicator 150 to the modification manager 160. The bitstream analyzer 194 also provides the one or more feature indicators 152, if retrieved from the bitstream 145, to the modification manager 160. The bitstream analyzer 194 provides the encoded image data 124 to the decoder 162. The decoder 162 decodes the encoded image data 124 to generate a decoded image frame 172 and provides the decoded image frame 172 to the modification manager 160.

The modification manager 160, in response to receiving the decoded image frame 172, determines whether an image modification is to be performed. For example, the modification manager 160, in response to determining that the modification indicator 150 indicates that image modification is sender prohibited, determines that image modification is not to be performed. Alternatively, the modification manager 160, in response to determining that the modification indicator 150 indicates that image modification is sender permitted, performs a comparison of the feature indicator(s) 152 and the recipient permitted feature indicator(s) 184 to determine whether at least one modification feature is permitted (e.g., both sender permitted and recipient permitted).

In an example, the modification manager 160, based on determining that a first feature indicator 152 indicates that a feature A is sender permitted and that a first recipient permitted feature indicator 184 indicates that the feature A is recipient permitted, determines that the feature A is permitted. As another example, the modification manager 160, based on determining that a second feature indicator 152 indicates that the feature B is sender prohibited or that the second feature indicator 152 is not included in the bitstream 145, determines that the feature B is sender prohibited. The modification manager 160, based on determining that the feature B is sender prohibited and independently of whether the feature B is recipient permitted, determines that the feature B is prohibited. Similarly, the modification manager 160, in response to determining that a recipient permitted feature indicator 184 indicates that a feature C is recipient prohibited and independently of whether the feature C is sender permitted, determines that the feature C is prohibited. In another example, the modification manager 160, in response to determining that a recipient permitted feature indicator 184 indicates that a feature D is recipient prohibited and independently of whether the feature D is sender permitted, determines that feature D is prohibited.

In some embodiments, the modification manager 160, in response to determining that at least one modification feature is permitted, determines that image modification is to be performed. In other embodiments, the modification manager 160, in response to determining that at least one modification feature is permitted, determines whether at least one permitted modification feature is performable on (e.g., applicable to) the decoded image frame 172. For example, the facial landmark detector 146, based on determining that at least one permitted modification feature uses facial landmark data, selectively performs facial landmark detection on the decoded image frame 172 to generate facial landmark data 154. The modification manager 160, in response to determining that the facial landmark data 154 includes modification data (e.g., indicating detected eye landmarks) that is useable to perform the permitted modification feature (e.g., gaze correction), determines that the permitted modification feature is performable on the decoded image frame 172. Alternatively, the modification manager 160, in response to determining that the facial landmark data 154 includes invalid data (e.g., no facial landmarks detected) or includes modification data (e.g., detected landmarks do not include eye landmarks) that is not useable to perform the permitted modification feature (e.g., gaze correction), determines that the modification feature is not performable. The modification manager 160, in response to determining that at least one permitted modification feature is performable, determines that image modification is to be performed.

The modification manager 160 selectively generates a modified image frame at least partially based on whether image modification is to be performed. For example, the modification manager 160, in response to determining that image modification is not to be performed, designates the decoded image frame 172 as an output image frame 186. Alternatively, the modification manager 160, based at least in part on determining that image modification is to be performed, performs a modification of the decoded image frame 172 to generate a modified image frame (e.g., the output image frame 186).

In an example, the modification manager 160 performs one or more permitted modification features that are performable on the decoded image frame 172 to generate image data 174 and combines the decoded image frame 172 and the image data 174 to generate the output image frame 186, as described with reference to FIG. 3. To illustrate, the modification manager 160, based on a determination that the modification indicator 150 indicates that image modification is sender permitted, that a feature indicator 152 indicates that a modification feature associated with the decoded image frame 172 (e.g., corresponding to the input image frame 122) is sender permitted, that a recipient permitted feature indicator 184 indicates that the modification feature is recipient permitted, and that modification data (e.g., the facial landmark data 154) indicates that the modification feature is performable on the decoded image frame 172, performs a modification on the decoded image frame 172 to generate the output image frame 186.

Optionally, in some embodiments, the modification manager 160 adds a visual indicator on the output image frame 186, generates an audio indicator, or both, to indicate whether original input has been modified (e.g., modification features have been performed) to generate the output image frame 186. The modification manager 160 provides the output image frame 186 to the display device 170. In some embodiments, the modification manager 160 provides the audio indicator to a speaker for audio playout concurrently with providing the output image frame 186 to the display device 170.

It should be understood that gaze correction is provided as an example of a modification feature that is based on facial landmark detection, in some other examples other types of modification features (e.g., a beautification filter) can be performed based on facial landmark data corresponding to a detected face. It should be understood that the facial landmark detector 146 is provided as an example of a modification data generator, and in some other examples another type of modification data generator (e.g., a room detector) can be used to generate modification data and the modification manager 160 can determine whether a modification feature (e.g., room decor modification) is performable based on the modification data.

A technical advantage of the system 100 includes enabling generation of the output image frame 186 that includes modification features that are sender permitted, performable, and optionally in some examples recipient permitted. The output image frame 186 corresponds to a modified version of the input image frame 122 that includes the permitted and performable modification features. Another advantage includes bandwidth reduction by selectively sending the one or more feature indicators 152. For example, the one or more feature indicators 152 are not sent when the modification indicator 150 indicates that image modification is sender prohibited. The system 100 also enables compatibility with legacy recipient devices that can playback video data without extracting the modification indicator 150 or the one or more feature indicators 152 from the bitstream 145.

It should be understood that the modification manager 160 performing a modification feature that is individually sender permitted and individually recipient permitted is provided as an illustrative example. Optionally, in some embodiments, a set of modification features may be selectively sender permitted as a group. For example, the modification manager 140 of the device 102 sends the modification indicator 150, and the modification manager 160 of the device 104 determines that all performable modification features are sender permitted when the modification indicator 150 has a first value (e.g., 1) indicating that image modification is sender permitted. To illustrate, the user 101 can provide user input 103 to opt all-in or all-out of image modification. Optionally, in some embodiments, a set of modification features may be selectively recipient permitted as a group. For example, the modification manager 160 determines that all performable modification features are recipient permitted when a particular recipient permitted feature indicator has a first value (e.g., 1) indicating that image modification is recipient permitted. To illustrate, the user 105 can provide user input 107 to opt all-in or all-out of image modification. Optionally, in some embodiments, the modification manager 160 performs a modification feature that is sender permitted (e.g., based on the modification indicator 150, a feature indicator 152, or both) independently of whether the modification feature is recipient permitted.

It should be understood that a device can include one or more components of the device 102 and one or more components of the device 104. For example, the device 102 can correspond to a sender device for a first video stream to the device 104, and also correspond to a recipient device for a second video stream from the device 104 or from another device. In this example, the one or more processors 190 of the device 102 include a bitstream analyzer 194, a modification manager 160, a decoder 162, or a combination thereof, and the one or more processors 190 are optionally coupled to a display device 170.

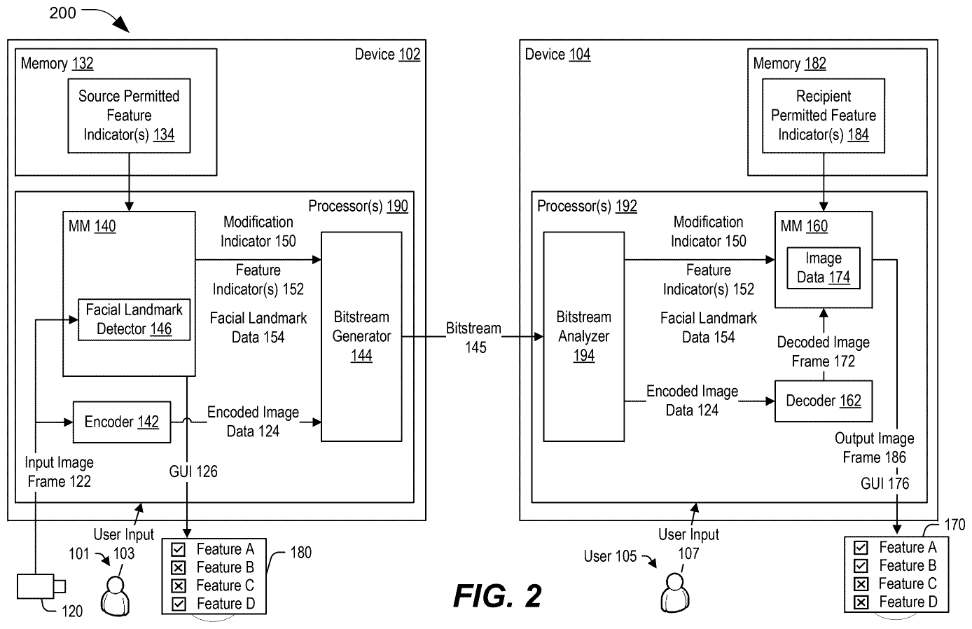

Referring to FIG. 2, a particular illustrative aspect of a system 200 operable to perform selective image frame modification is disclosed, in accordance with some examples of the present disclosure. In a particular aspect, the system 100 of FIG. 1 includes one or more components of the system 200.

In the system 200, the modification manager 140 of the device 102 (e.g., the sender device) includes a facial landmark detector 146, alternatively or in addition, to the modification manager 160 of the device 104 (e.g., the recipient device) including another modification data generator (e.g., another facial landmark detector 146 or one or more other types of modification data generators).

It should be understood that the facial landmark detector 146 is provided as an illustrative example of a modification data generator that is configured to generate modification data that can be used to facilitate application of a corresponding image modification. In some other examples the modification manager 140 can include the facial landmark detector 146, one or more other types of modification data generators, or a combination thereof.

The modification manager 140 obtains the input image frame 122 from the image source 120 and selectively uses one or more modification data generators (e.g., including the facial landmark detector 146) to generate modification data. For example, in some embodiments, the modification manager 140 selectively uses a modification data generator (e.g., the facial landmark detector 146) to generate modification data based on determining that at least one source permitted modification feature (e.g., as indicated by the one or more source permitted feature indicators 134) is associated with the type of modification data (e.g., facial landmark data) generated by the modification data generator. For example, the modification manager 140, in response to determining that image modification is not permitted or that none of the source permitted modification features use facial landmark data, bypasses (e.g., disables) the facial landmark detector 146 to conserve resources (e.g., battery life, memory usage, computation time, etc.).

Optionally, in some embodiments, the modification manager 140 selectively processes the input image frame 122 to generate modification data (e.g., the facial landmark data 154) based on determining that one or more modification data generation criteria are satisfied. For example, the modification manager 140, based on determining that the device 102 has at least threshold resources (e.g., battery life, memory resources, or both), determines that a modification data generation criterion is satisfied. As another example, the modification manager 140, based on determining that an encoding bitrate of the encoded image data 124 is lower than bitrate threshold and indicates that generating the modification data based on decoded image data at a recipient device is likely to result in low quality modification data, determines that a modification data generation criterion is satisfied. In a particular aspect, the modification manager 140 processes the input image frame 122 concurrently with the encoder 142 processing the input image frame 122.

The modification manager 140 provides modification data, if generated, to the bitstream generator 144 and the bitstream generator 144 includes the modification data in the bitstream 145. Optionally, in some embodiments, the modification manager 140, based at least in part on determining that a modification feature is source permitted and that the modification data indicates that the modification feature is performable on the input image frame 122 (as described with reference to FIG. 1), selectively provides the corresponding modification data to the bitstream generator 144 to include the modification data in the bitstream 145. For example, the modification manager 140, based on determining that the facial landmark data 154 indicates that a source permitted modification feature is performable (as described with reference to FIG. 1), provides the facial landmark data 154 to the bitstream generator 144 to include in the bitstream 145. Alternatively, the modification manager 140, based on determining that the facial landmark data 154 is not useable to perform any permitted modification feature (as described with reference to FIG. 1), refrains from providing the facial landmark data 154 to the bitstream generator 144 and the facial landmark data 154 is not included in the bitstream 145.

In some aspects, the bitstream generator 144 selectively includes modification data in the bitstream 145 based on a comparison with previously sent modification data. In an example, the modification manager 140 uses the facial landmark detector 146 to generate first facial landmark data 154 of a first input image frame 122, and the bitstream generator 144 sends the first facial landmark data 154 in the bitstream 145. Subsequently, the modification manager 140 uses the facial landmark detector 146 to generate second facial landmark data 154 of a second input image frame 122. In some embodiments, the bitstream generator 144 includes the second facial landmark data 154 in the bitstream 145. In other embodiments, the bitstream generator 144 selectively includes the second facial landmark data 154 in the bitstream 145 based on determining that a landmark update criterion is satisfied.

In an example, the bitstream generator 144 determines that the landmark update criterion is satisfied in response to detecting a deviation of the second facial landmark data 154 from the first facial landmark data 154 that is greater than threshold deviation. In some cases, the bitstream generator 144 empirically determines the threshold deviation based on video quality data received from the device 104. In some cases, the threshold deviation is based on a user input, a configuration setting, default data, or a combination thereof. In another example, the bitstream generator 144 determines that the landmark update criterion is satisfied in response to determining that at least a threshold count of input image frames (e.g., 30 frames or 60 frames) between the first input image frame 122 and the input image frame 122 have elapsed for which the facial landmark data 154 has not been included in the bitstream 145. In some embodiments, the bitstream generator 144 determines that the landmark update criterion is satisfied in response to determining that the input image frame 122 corresponds to (e.g., is encoded as) a particular frame type (e.g., a key frame, such as an I-frame).

Optionally, in some embodiments, a feature indicator 152, in addition to indicating whether a modification feature is source permitted, also indicates whether the modification feature is likely to be performable. For example, the modification manager 140 generates a feature indicator 152 of a modification feature based on a source permitted feature indicator 134 of the modification feature and whether corresponding modification data indicates that the modification feature is performable on the input image frame 122. For example, the modification manager 140, based on determining that a source permitted feature indicator 134 indicates that a modification feature A (e.g., gaze correction) is source permitted and that the facial landmark data 154 indicates that the modification feature A is performable (e.g., an eye is detected), generates a feature indicator 152 to have a value (e.g., 1) indicating that the modification feature A is sender permitted (e.g., source permitted and likely to be performable), and selectively sends the feature indicator 152 to the bitstream generator 144 to include in the bitstream 145. Alternatively, the modification manager 140, based on determining that the source permitted feature indicator 134 indicates that the modification feature A (e.g., gaze correction) is not source permitted, that the facial landmark data 154 indicates that the modification feature A is not performable (e.g., no eye is detected), or both, generates the feature indicator 152 to have a value (e.g., 0) indicating that the modification feature A is not sender permitted (e.g., is not source permitted, is not performable, or both).

Optionally, in some embodiments, the modification manager 140 may be unable to determine whether a modification feature is performable and generates a feature indicator 152 based on whether the modification feature is source permitted and independently of whether the modification feature is performable, as described with reference to FIG. 1. In an example, the modification manager 140 does not have access to a second modification data generator associated with a modification feature B (e.g., room decor modifier). In this example, the modification manager 140, in response to determining that the modification feature B is source permitted, generates the second feature indicator 152 having a first value (e.g., 1) indicating that the modification feature B is sender permitted (e.g., source permitted and likely to be performable). Alternatively, the modification manager 140, in response to determining that the modification feature B is not source permitted, generates a second feature indicator 152 having a second value (e.g., 0) indicating that the modification feature B is sender prohibited (e.g., source prohibited, not performable, or both). The modification manager 140 can thus generate a first feature indicator 152 based on whether the modification feature A is source permitted (e.g., as indicated by a first source permitted feature indicator 134) and performable (e.g., as indicated by the facial landmark data 154), and generate the second feature indicator 152 based on whether the modification feature B is source permitted (e.g., as indicated by a second source permitted feature indicator 134) and independently of whether the modification feature B is performable.

In a particular embodiment, a feature indicator 152 includes a source permitted indicator and a performable indicator. The source permitted indicator has the same value as the corresponding source permitted feature indicator 134. The performable indicator can have a first value (e.g., 0) to indicate that the modification feature is not performable, a second value (e.g., 1) to indicate that modification feature is performable, or a third value (e.g., 2) to indicate that performability of the modification feature is undetermined.

The modification manager 140, in response to determining that at least one source permitted modification feature is likely to be performable (e.g., is performable or performability is undetermined), generates the modification indicator 150 having a first value (e.g., 1) indicating that image modification is sender permitted. Alternatively, the modification manager 140, in response to determining that each of the modification features is either source prohibited or not performable, generates the modification indicator 150 having a second value (e.g., 0) indicating that image modification is sender prohibited. The modification manager 140 provides the modification indicator 150 to the bitstream generator 144 to include in the bitstream 145. Optionally, in some embodiments, the modification manager 140 selectively provides the one or more feature indicators 152 to the bitstream generator 144 based on whether image modification is sender permitted, as described with reference to FIG. 1.

The device 104 receives the bitstream 145 from the device 102 during a video communication between the device 102 and the device 104. The bitstream analyzer 194 obtains the encoded image data 124 as part of the video communication and optionally the modification indicator 150, the feature indicator(s) 152, modification data (e.g., the facial landmark data 154), or a combination thereof, from the received bitstream 145. In a particular embodiment, the encoded image data 124 and the modification indicator 150 are standard-compliant (e.g., included in a standard-compliant SEI message) and the facial landmark data 154 is included as additional non-standard data.

In some of these embodiments, the modification indicator 150, a feature indicator 152 corresponding to a modification feature that uses facial landmark, or both, correspond to an indicator of whether the additional non-standard data is present in the bitstream 145. In an example, the bitstream analyzer 194, in response to determining that the modification indicator 150 has a first value (e.g., 0) indicating that image modification is sender prohibited and that additional non-standard data is not present, refrains from parsing the bitstream 145 to extract the facial landmark data 154. Alternatively, in some examples, the bitstream analyzer 194, in response to determining that the modification indicator 150 has a second value (e.g., 1) indicating that image modification is sender permitted, determines that additional non-standard data is present and parses the bitstream 145 to extract the facial landmark data 154. In yet other examples, the bitstream analyzer 194, in response to determining that the modification indicator 150 has the second value (e.g., 1) and at least one feature indicator 152 corresponding to a modification feature that uses facial landmark data has a second value (e.g., 1) indicating that the modification feature is sender permitted, determines that the additional non-standard data is present and parses the bitstream 145 to extract the facial landmark data 154.

The bitstream analyzer 194, in response to determining that additional non-standard data is present, parses the bitstream 145 to extract the facial landmark data 154. The bitstream analyzer 194 provides the modification indicator 150, the one or more feature indicators 152, the modification data (e.g., the facial landmark data 154), or a combination thereof, if available in the bitstream 145, to the modification manager 160.

The modification manager 160, in response to determining that at least one modification feature is permitted (e.g., sender permitted and recipient permitted), determines whether at least one permitted modification feature is performable on (e.g., applicable to) the decoded image frame 172. For example, the modification manager 160, based on determining that the bitstream 145 includes modification data (e.g., the facial landmark data 154) useable to perform a permitted modification feature, determines that the modification feature is performable. Alternatively, the modification manager 160, based on determining that the bitstream 145 includes modification data (e.g., the facial landmark data 154) associated with the permitted modification feature and that the modification data indicates that the modification feature is not performable, determines that the modification feature is not performable.

Optionally, in some embodiments, the modification manager 160, based on determining that modification data associated with a permitted modification feature is unavailable (e.g., is not included or has not been received) in the bitstream 145, analyzes the decoded image frame 172 to determine whether the modification feature is performable on the decoded image frame 172, as described with reference to FIG. 1. For example, in an embodiment in which the modification manager 160 includes a modification data generator (e.g., a facial landmark detector 146), the modification manager 160 uses the modification data generator to process the decoded image frame 172 to generate the modification data (e.g., the facial landmark data 154) and, based on the modification data, determines whether the modification feature is performable, as described with reference to FIG. 1.

The modification manager 160 selectively generates a modified image frame at least partially based on whether image modification is permitted or prohibited, as described with reference to FIG. 1. For example, the modification manager 160, in response to determining that no modification is to be performed, designates the decoded image frame 172 as an output image frame 186. Alternatively, the modification manager 160, based at least in part on determining that image modification is to be performed, performs a modification of the decoded image frame 172 to generate a modified image frame (e.g., the output image frame 186), as described with reference to FIG. 1. For example, the modification manager 160 performs a permitted modification feature on the decoded image frame 172 based on modification data (e.g., the facial landmark data 154 received in the bitstream 145 or generated locally at the device 104) to generate the image data 174 and generates the output image frame 186 based on a combination of the decoded image frame 172 and the image data 174. The modification manager 160 provides the output image frame 186 to the display device 170, as described with reference to FIG. 1.

In some examples, the decoder 162 receives first encoded image data 124 that represents a first input image frame 122 of a sequence of image frames (e.g., of a video) in the bitstream 145 and processes the first encoded image data 124 to generate the first decoded image frame 172. Optionally, in some embodiments, the modification manager 160 receives first facial landmark data 154 of the first input image frame 122 in the bitstream 145 and generates first image data 174 based on the first facial landmark data 154 and the first decoded image frame 172. The modification manager 160 generates a first output image frame 186 (e.g., a first modified image frame) based on the first decoded image frame 172 and the first image data 174. Subsequently, the decoder 162 receives second encoded image data 124 that represents a second input image frame 122 of the sequence of image frames in the bitstream 145 and processes the second encoded image data 124 to generate a second decoded image frame 172.

In an example, the modification manager 160 determines that second facial landmark data 154 of the second input image frame 122 is unavailable (e.g., is not included or has not been received) in the bitstream 145. Optionally, in some embodiments, the modification manager 160, in response to determining that the second facial landmark data 154 is unavailable, generates the second output image frame 186 (e.g., a second modified image frame) based on a combination of the first image data 174 and the second decoded image frame 172. Optionally, in some embodiments, the modification manager 160, in response to determining that the second facial landmark data 154 is unavailable, predicts (e.g., estimates) second image data 174 based at least in part on the first image data 174, the first decoded image frame 172, the second decoded image frame 172, or a combination thereof, and combines the predicted second image data 174 and the decoded image frame 172 to generate the second output image frame 186.

Optionally, in some embodiments, the modification manager 140 at the device 102 (e.g., the sender device) applies the modification feature to an image frame (e.g., the input image frame 122 or a locally decoded image frame generated from the encoded image data 124) based on the facial landmark data 154 to generate the image data 174. The modification manager 140 provides the image data 174 to the bitstream generator 144 to include in the bitstream 145 as additional image data. In some of these embodiments, the modification manager 140 refrains from providing the facial landmark data 154 to the bitstream generator 144 and the facial landmark data 154 is not included in the bitstream 145. The bitstream analyzer 194 at the device 104 (e.g., the recipient device) obtains the image data 174 from the bitstream 145 and provides the image data 174 to the modification manager 160. The modification manager 160, based on determining that the modification feature is permitted (e.g., sender permitted and recipient permitted), generates the output image frame 186 based on a combination of the image data 174 received in the bitstream 145 and the decoded image frame 172.

Optionally, in some embodiments, the bitstream analyzer 194 receives first image data 174 and first encoded image data 124 associated with a first input image frame 122 in the bitstream 145, the decoder 162 processes the first encoded image data 124 to generate first decoded image frame 172, and the modification manager 160 generates a first output image frame 186 based on the first decoded image frame 172 and the first image data 174. Subsequently, the bitstream analyzer 194 receives second encoded image data 124 associated with a second input image frame 122 in the bitstream 145 and determines that second image data 174 is unavailable (e.g., is not included or has not been received) in the bitstream 145.

The modification manager 160, in response to determining that the second image data 174 is unavailable, generates a second output image frame 186 based on the first image data 174 and the second encoded image data 124. For example, the modification manager 160 processes the second encoded image data 124 to generate a second decoded image frame 172. Optionally, in some embodiments, the modification manager 160 combines the first image data 174 and the second decoded image frame 172 to generate the second output image frame 186. Optionally, in some other embodiments, the modification manager 160 predicts (e.g., estimates) second image data 174 based at least in part on the first image data 174, the first decoded image frame 172, the second decoded image frame 172, or a combination thereof, and combines the predicted second image data 174 and the decoded image frame 172 to generate the second output image frame 186.

FIG. 3 depicts an example 300 of an illustrative aspect of operations associated with the modification manager 160 of the system 100 of FIG. 1 or the system 200 of FIG. 2, in accordance with some examples of the present disclosure.

The modification manager 160 obtains a portion of the decoded image frame 172 that corresponds to a permitted modification feature. For example, at 302, the modification manager 160, based on determining that the modification feature is associated with facial modification, crops the decoded image frame 172 to generate a cropped image frame 372 representing a face detected in the decoded image frame 172. In some embodiments, the modification manager 160 crops the decoded image frame 172 based on the facial landmark data 154. For example, the modification manager 160, based on determining that the facial landmark data 154 indicates eye corner landmark coordinates, determines an eye strip width and an eye strip center based on the eye corner landmark coordinates. In a particular aspect, the eye strip center corresponds to pixel coordinates of an estimated center (e.g., equidistant) between the eye inner corners in the decoded image frame 172. In a particular aspect, the eye strip width corresponds to a pixel distance between eye outer corners in the decoded image frame 172.

In a particular embodiment, the modification manager 160 determines a crop width 318 and a crop height 320 based on the eye strip width and a padding factor (e.g., crop width =crop height=eye strip width*padding factor). In some examples, the padding factor is 1.5. The modification manager 160 determines a crop center 322 corresponding to a center point of a crop box 324. The crop box 324 has the crop width 318 and the crop height 320. The crop center 322 has the same horizontal pixel coordinate as the eye strip center 316. The crop center 322 has a vertical pixel coordinate such that that an upper portion of the crop box 324 (e.g., 25 percent of the crop height 320) is above the vertical pixel coordinate of the eye strip center 316 and a remaining portion of the crop box 324 (e.g., 75 percent of the crop height 320) is below the vertical pixel coordinate of the eye strip center 316. The modification manager 160 extracts (e.g., crops) a portion of the decoded image frame 172 corresponding to the crop box 324 to generate the cropped image frame 372.

The modification manager 160 applies the modification feature to the cropped image frame 372 to generate the image data 174. For example, at 304, the modification manager 160 performs modification feature synthesis on the cropped image frame 372 to generate image data 174 and optionally also position data 306, auxiliary data 308, or both. In a particular aspect, the modification manager 160 includes a neural network (e.g., a convolutional neural network (CNN)) and uses the neural network to process the cropped image frame 372 to generate the image data 174, the position data 306, the auxiliary data 308, or a combination thereof.

In an example, the modification feature synthesis corresponds to performing gaze correction to change the gaze direction from looking away in the cropped image frame 372 to looking forward in the image data 174. The position data 306 indicates a position of the synthesized image portion represented by the image data 174 in the cropped image frame 372, the decoded image frame 172, or both. For example, the position data 306 can indicate coordinates of the top-left corner of an image portion in the decoded image frame 172 that corresponds to (e.g., is to be replaced by) the synthesized image portion.

The auxiliary data 308 includes additional information that can be used to determine whether the image data 174 generated using the modification feature synthesis satisfies a quality criterion. In an example, the auxiliary data 308 includes a head pose angle estimate corresponding to a detected head pose in the cropped image frame 372, an eye gaze angle estimate corresponding to a detected eye gaze in the cropped image frame 372, a predicted quality confidence of the image data 174, or a combination thereof. In a particular aspect, the modification manager 160 uses a generative adversarial network (GAN) to generate at least part of the auxiliary data 308 (e.g., the predicted quality confidence) based on the decoded image frame 172, the cropped image frame 372, the image data 174, or a combination thereof. A GAN typically includes a generator portion and a discriminator portion. In some examples, the generator portion can be trained to generate modified portions of an original image and the discriminator can be trained to assess the realism of modified images that are generated by combining the modified portions with the original image and to generate a corresponding confidence score. The trained GAN (e.g., the discriminator) can be used to generate a predicted quality confidence (e.g., a confidence score) based on the decoded image frame 172, the cropped image frame 372, the image data 174, or a combination thereof. Training a GAN to generate a predicted quality confidence is provided as an illustrative example; in other examples a GAN can be similarly trained to generate other types of auxiliary data 308.

At 310, the modification manager 160 performs a quality check based on the auxiliary data 308 to determine whether to use the image data 174 to modify the decoded image frame 172. For example, the modification manager 160, based on determining that the detected head pose angle in the cropped image frame 372 is greater than a pose angle threshold (e.g., the head is rotated away), determines that a natural-looking gaze correction is not feasible, determines that the image data 174 does not satisfy the quality criterion, and outputs the decoded image frame 172 as the output image frame 186.

As another example, the modification manager 160, based on determining that the detected eye gaze angle is less than or equal to a target gaze threshold, determines that eye gaze correction does not have to be performed (e.g., because the eye gaze is already directed to the camera), determines that the image data 174 does not satisfy the quality criterion, and outputs the decoded image frame 172 as the output image frame 186. In yet another example, the modification manager 160, based on determining that the predicted quality confidence of the image data 174 is less than a confidence threshold, determines that the eye gaze correction is likely to be low quality, determines that the image data 174 does not satisfy the quality criterion, and outputs the decoded image frame 172 as the output image frame 186. Alternatively, the modification manager 160, in response to determining that the detected head pose angle is less than or equal to the pose angle threshold, that the detected eye gaze angle is greater than the target gaze threshold, and that the predicted quality confidence is greater than or equal to the confidence threshold, determines that the image data 174 satisfies the quality criterion.

At 312, the modification manager 160, in response to determining that the image data 174 satisfies the quality criterion, merges the decoded image frame 172 and the image data 174 based on the facial landmark data 154 to generate the output image frame 186. For example, the modification manager 160 uses the facial landmark data 154 to generate a mask 314 (e.g., a two-dimensional Gaussian mask) centered on the eyes indicated by the facial landmark data 154. To illustrate, a horizontal (x) variance and a vertical (y) variance of the mask 314 are based on an eye height and an eye width indicated by the facial landmark data 154.

The modification manager 160 uses the values of the mask 314 to determine weights for combining the synthesized image portion represented by the image data 174 and a corresponding decoded image portion of the decoded image frame 172. For example, the modification manager 160 uses a weighted combination of a decoded pixel value of the decoded image portion and a synthesized pixel value of the synthesized image portion to determine an output pixel value of a corresponding output image portion of the output image frame 186 (e.g., output pixel value=m*synthesized pixel value+(1−m)*decoded pixel value, where m is a corresponding mask pixel value of the mask 314 and represents a value in the range of 0 to 1). The remaining pixel values of the output image frame 186 are based on (e.g., are equal to) corresponding pixel values of the decoded image frame 172.

Optionally in some embodiments, the modification manager 160 is configured to perform multiple modification features. In some examples, the modification manager 160 performs the modification features sequentially. To illustrate, the decoded image frame 172 is used as an input image frame to perform the first modification feature to generate an output image frame. An output image frame generated by performing a previous modification feature is used as an input image frame for performing a subsequent modification feature. An output image frame of the last modification feature is output as the output image frame 186. In some examples, the modification manager 160 can concurrently perform multiple modifications features to different portions of an image frame. For example, gaze correction can be performed concurrently on different faces detected in the decoded image frame 172 to generate corresponding portions of the output image frame 186. As another example, gaze correction can be performed on a face detected in the decoded image frame 172 to generate a corresponding portion of the output image frame 186 concurrently with performing room decor modification on another portion of the decoded image frame 172 to generate another corresponding portion of the output image frame 186.

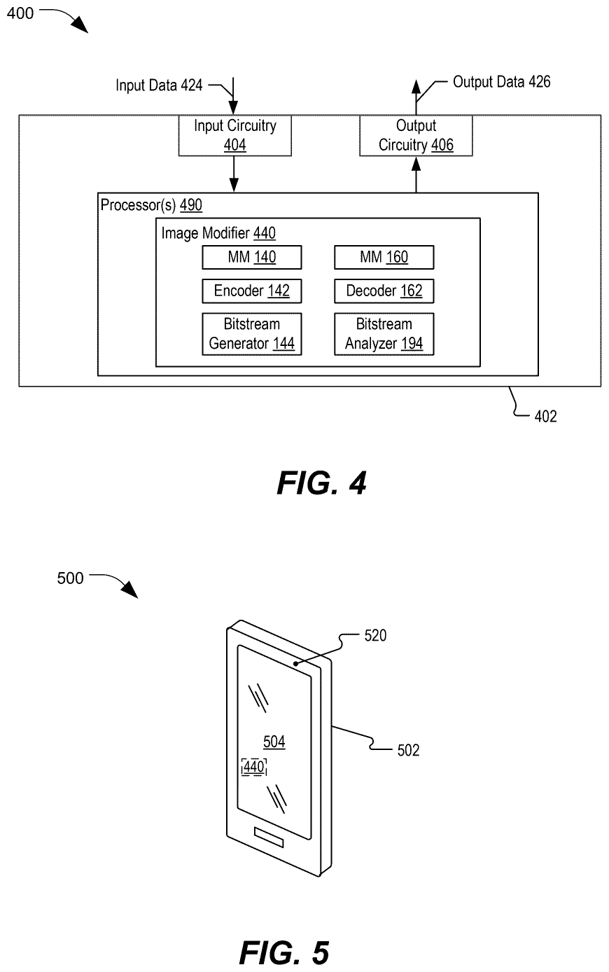

FIG. 4 depicts an implementation 400 of the device 102, the device 104, or both, as an integrated circuit 402 that includes one or more processors 490. For example, the one or more processors 490 correspond to the one or more processors 190, the one or more processors 192 of FIG. 1, or both. The one or more processors 490 include an image modifier 440 that includes the modification manager 140, the encoder 142, the bitstream generator 144, the modification manager 160, the decoder 162, the bitstream analyzer 194, or a combination thereof.

The integrated circuit 402 also includes input circuitry 404, such as one or more bus interfaces, to enable input data 424 to be received for processing. In some examples, the input data 424 can include the user input 103, the input image frame 122, the encoded image data 124, the modification indicator 150, the one or more feature indicators 152, the one or more source permitted feature indicators 134, the bitstream 145, the decoded image frame 172, the image data 174, the facial landmark data 154, modification data, the one or more recipient permitted feature indicators 184, the user input 107, or a combination thereof.

The integrated circuit 402 also includes output circuitry 406, such as a bus interface, to enable sending of output data 426. In some examples, the output data 426 can include the GUI 126, the encoded image data 124, the modification indicator 150, the one or more feature indicators 152, the bitstream 145, the decoded image frame 172, the image data 174, the facial landmark data 154, the output image frame 186, the GUI 176, or a combination thereof.

The integrated circuit 402 enables implementation of selective image frame modification as a component in a system, such as a mobile phone or tablet as depicted in FIG. 5, a wearable electronic device as depicted in FIG. 6, a mixed reality or augmented reality glasses device, as described with reference to FIG. 7, a voice-controlled speaker system as depicted in FIG. 8, a camera as depicted in FIG. 9, a virtual reality, mixed reality, or augmented reality headset as depicted in FIG. 10, or a vehicle as depicted in FIG. 11 or FIG. 12.

FIG. 5 depicts an implementation 500 in which the device 102 includes a mobile device 502, such as a phone or tablet, as illustrative, non-limiting examples. The mobile device 502 includes a camera 520 and a display screen 504. In some examples, the camera 520 corresponds to the image source 120 of FIG. 1, the display screen 504 corresponds to the display device 170 of FIG. 1, or both.

Components of the one or more processors 190, including the image modifier 440, are integrated in the mobile device 502 and are illustrated using dashed lines to indicate internal components that are not generally visible to a user of the mobile device 502. In a particular example, the mobile device 502 operates to detect user voice activity, which is then processed to perform one or more operations at the mobile device 502, such as to launch a graphical user interface or otherwise display other information associated with the user's speech at the display screen 504 (e.g., via an integrated “smart assistant” application). For example, the mobile device 502, based on receiving a voice command to initiate or accept a video call, obtains video data from the camera 520 and transmits a first bitstream 145 to another device, as described with reference to the device 102 of FIG. 1, and receives a second bitstream 145 from the other device and provides output image data to the display screen 504, as described with reference to the device 104 of FIG. 1.

FIG. 6 depicts an implementation 600 in which the device 102 includes a wearable electronic device 602, illustrated as a “smart watch.” The image modifier 440 and a camera 620 are integrated into the wearable electronic device 602. In some examples, the camera 620 corresponds to the image source 120 of FIG. 1.

Components of the one or more processors 190, including the image modifier 440, are integrated in the wearable electronic device 602 and are illustrated using dashed lines to indicate internal components that are not generally visible to a user of the wearable electronic device 602. In a particular example, the wearable electronic device 602 operates to detect user voice activity, which is then processed to perform one or more operations at the wearable electronic device 602, such as to launch a graphical user interface or otherwise display other information associated with the user's speech at a display screen 604 of the wearable electronic device 602. For example, the wearable electronic device 602, based on receiving a voice command to initiate or accept a video call, obtains video data from the camera 620 and transmits a first bitstream 145 to another device, as described with reference to the device 102 of FIG. 1, and receives a second bitstream 145 from the other device and provides output image data to the display screen 604, as described with reference to the device 104 of FIG. 1.

To illustrate, the display screen 604 may display a notification based on user speech detected by the wearable electronic device 602 to indicate that the video call is in-progress, to display video data captured using the camera 620, to display the output image data, or a combination thereof. In a particular example, the wearable electronic device 602 includes a haptic device that provides a haptic notification (e.g., vibrates) in response to detection of user voice activity or an incoming video call. For example, the haptic notification can cause a user to look at the wearable electronic device 602 to see a displayed notification indicating detection of a keyword spoken by the user. The wearable electronic device 602 can thus alert a user with a hearing impairment or a user wearing a headset that the user's voice activity is detected or that a video call is requested.

FIG. 7 depicts an implementation 700 in which the device 102 includes a portable electronic device that corresponds to augmented reality or mixed reality glasses 702. The glasses 702 include a holographic projection unit 704 configured to project visual data onto a surface of a lens 706 or to reflect the visual data off of a surface of the lens 706 and onto the wearer's retina. The image modifier 440 and a camera 720 are integrated into the glasses 702. The image modifier 440 may function to generate a first bitstream 145 based on an input image frame 122 received from the camera 720, generate an output image frame 186 based on a second bitstream 145 received from another device, or both. In a particular example, the holographic projection unit 704 is configured to display a notification indicating that a video call is in-progress, display the output image frame 186, or both. For example, the notification, the output image frame 186, or both, can be superimposed on the user's field of view. To illustrate, sound corresponding to the output image frame 186 (e.g., audio of the video call) may be perceived by the user as emanating from the direction of the notification.

FIG. 8 is an implementation 800 in which the device 102 includes a wireless speaker and voice activated device 802. The wireless speaker and voice activated device 802 can have wireless network connectivity and is configured to execute an assistant operation. The one or more processors 190 including the image modifier 440, a camera 820, a speaker 804, and a display screen 806 are included in the wireless speaker and voice activated device 802. In a particular example, the camera 820 corresponds to the image source 120 of FIG. 1, the display screen 806 corresponds to the display device 170 of FIG. 1, or both.

During operation, in response to receiving a verbal command identified as user speech, the wireless speaker and voice activated device 802 can execute assistant operations, such as via execution of a voice activation system (e.g., an integrated assistant application). The assistant operations can include adjusting a temperature, playing music, turning on lights, initiating or accepting a video call, etc. For example, the assistant operations are performed responsive to receiving a command after a keyword or key phrase (e.g., “hello assistant”). For example, the wireless speaker and voice activated device 802, based on receiving a voice command to initiate or accept a video call, obtains video data from the camera 820 and transmits a first bitstream 145 to another device, as described with reference to the device 102 of FIG. 1, and receives a second bitstream 145 from the other device and provides output image data to the display screen 806, as described with reference to the device 104 of FIG. 1.

FIG. 9 depicts an implementation 900 in which the device 102 includes a portable electronic device that corresponds to a camera device 902. The image modifier 440 is included in the camera device 902. In some examples, the camera device 902 corresponds to the image source 120 of FIG. 1, includes a display screen (not shown) corresponding the display device 170 of FIG. 1, or both.

During operation, in response to receiving a verbal command identified as user speech, the camera device 902 can execute operations responsive to spoken user commands, such as to adjust image or video capture settings, video streaming settings, image or video playback settings, or image or video capture instructions, initiate or accept a video call, as illustrative examples. For example, the camera device 902, based on receiving a voice command to initiate or accept a video call, transmits a first bitstream 145 corresponding to input image data to another device, as described with reference to the device 102 of FIG. 1, and receives a second bitstream 145 from the other device and provides output image data to a display screen, as described with reference to the device 104 of FIG. 1.

FIG. 10 depicts an implementation 1000 in which the device 102 includes a portable electronic device that corresponds to a virtual reality, mixed reality, or augmented reality headset 1002. The image modifier 440 and a camera 1020 are integrated into the headset 1002. In some examples, the camera 1020 corresponds to the image source 120 of FIG. 1.

A visual interface device is positioned in front of the user's eyes to enable display of augmented reality, mixed reality, or virtual reality images or scenes to the user while the headset 1002 is worn. In an example, the headset 1002, based on receiving a user input to initiate or accept a video call, obtains input image data from the camera 1020 and transmits a first bitstream 145 to another device, as described with reference to the device 102 of FIG. 1, and receives a second bitstream 145 from the other device and provides output image data to the visual interface device to display, as described with reference to the device 104 of FIG. 1.

FIG. 11 depicts an implementation 1100 in which the device 102 corresponds to, or is integrated within, a vehicle 1102, illustrated as a manned or unmanned aerial device (e.g., a package delivery drone). The image modifier 440 and a camera 1120 are integrated into the vehicle 1102.

In an example, the vehicle 1102, based on receiving a user input to initiate or accept a video call, obtains input image data from the camera 1120 and transmits a first bitstream 145 to another device, as described with reference to the device 102 of FIG. 1, and receives a second bitstream 145 from the other device and provides output image data to a display screen (not shown), as described with reference to the device 104 of FIG. 1.

FIG. 12 depicts another implementation 1200 in which the device 102 corresponds to, or is integrated within, a vehicle 1202, illustrated as a car. The vehicle 1202 includes the one or more processors 190 including the image modifier 440. The vehicle 1202 also includes a speaker 1210, a camera 1220, and a display screen 1222.

In an example, the vehicle 1202, based on receiving a user input to initiate or accept a video call, obtains input image data from the camera 1220 and transmits a first bitstream 145 to another device, as described with reference to the device 102 of FIG. 1, and receives a second bitstream 145 from the other device and provides output image data to the display screen 1222, as described with reference to the device 104 of FIG. 1.

In some aspects, user voice activity detection can be performed based on audio signals received from a microphone of the vehicle 1202. In a particular implementation, in response to receiving a verbal command identified as user speech, a voice activation system initiates one or more operations of the vehicle 1202 based on one or more keywords (e.g., “unlock,” “start engine,” “play music,” “display weather forecast,” “accept video call,” “start video call,” or another voice command) detected in an audio signal, such as by providing feedback or information via the display screen 1222 or one or more speakers (e.g., the speaker 1210).

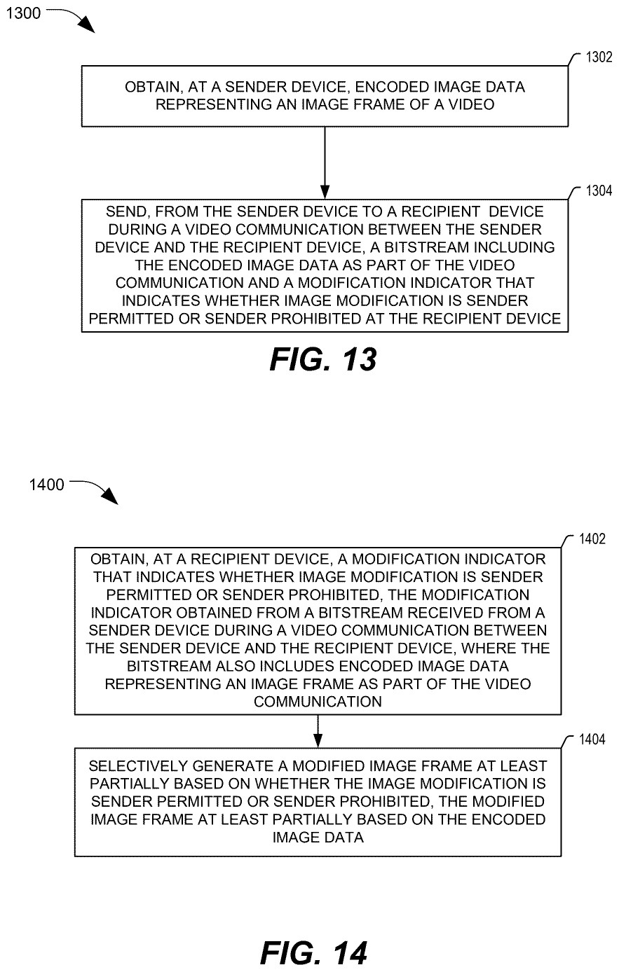

Referring to FIG. 13, a particular implementation of a method 1300 of performing selective image frame modification is shown. In a particular aspect, one or more operations of the method 1300 are performed by at least one of the modification manager 140, the encoder 142, the bitstream generator 144, the one or more processors 190, the device 102, the system 100 of FIG. 1, the system 200 of FIG. 2, the image modifier 440, the integrated circuit 402 of FIG. 4, or a combination thereof.

The method 1300 includes, at 1302, obtaining, at a sender device, encoded image data representing an image frame of a video. For example, the encoder 142 of the device 102 (e.g., a sender device) obtains (e.g., generates) the encoded image data 124 representing the input image frame 122 of a video, as described with reference to FIG. 1.

The method 1300 also includes, at 1304, sending, from the sender device to a recipient device during a video communication between the sender device and the recipient device, a bitstream including the encoded image data as part of the video communication and a modification indicator that indicates whether image modification is sender permitted or sender prohibited at the recipient device. For example, the bitstream generator 144 sends, from the device 102 (e.g., the sender device) to the device 104 (e.g., the recipient device) during a video communication (e.g., a video streaming session), the bitstream 145 including the encoded image data 124 as part of the video communication and the modification indicator 150 that indicates whether image modification is sender permitted or sender prohibited at the device 104, as described with reference to FIG. 1.

The method 1300 enables sending the encoded image data 124 corresponding to original input image frame 122 with at least the modification indicator 150 indicating whether image modification is sender permitted or sender prohibited at the device 104. The device 104 can generate the decoded image frame 172 that corresponds to original image data without modification features applied at the device 102 and can selectively perform one or more modification features based at least on whether image modification is sender permitted.

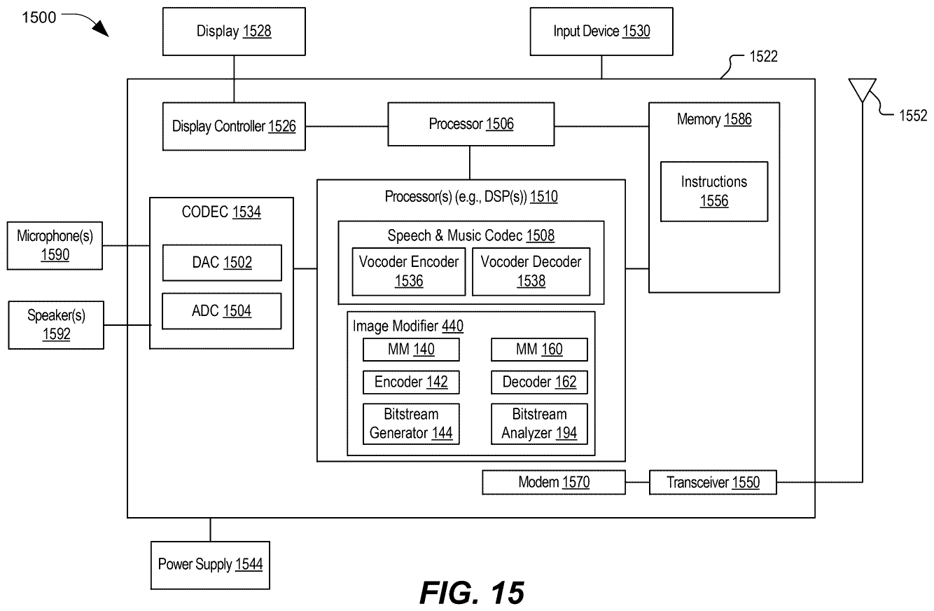

The method 1300 of FIG. 13 may be implemented by a field-programmable gate array (FPGA) device, an application-specific integrated circuit (ASIC), a processing unit such as a central processing unit (CPU), a digital signal processor (DSP), a controller, another hardware device, firmware device, or any combination thereof. As an example, the method 1300 of FIG. 13 may be performed by a processor that executes instructions, such as described with reference to FIG. 15.

Referring to FIG. 14, a particular implementation of a method 1400 of performing selective image frame modification is shown. In a particular aspect, one or more operations of the method 1400 are performed by at least one of the bitstream analyzer 194, the modification manager 160, the decoder 162, the one or more processors 192, the device 104, the system 100 of FIG. 1, the system 200 of FIG. 2, the image modifier 440, the integrated circuit 402 of FIG. 4, or a combination thereof.

The method 1400 includes, at 1402, obtaining, at a recipient device, a modification indicator that indicates whether image modification is sender permitted or sender prohibited, the modification indicator obtained from a bitstream received from a sender device during a video communication between the sender device and the recipient device, where the bitstream also includes encoded image data representing an image frame as part of the video communication. For example, the bitstream analyzer 194 of the device 104 (e.g., the recipient device) obtains the modification indicator 150 from the bitstream 145 received from device 102 during a video communication between the device 102 and the device 104, as described with reference to FIG. 1. The modification indicator 150 indicates whether image modification is sender permitted or sender prohibited. The bitstream 145 also includes the encoded image data 124 representing the input image frame 122 as part of the video communication.

The method 1400 includes, at 1404, selectively generating a modified image frame at least partially based on whether the image modification is sender permitted or sender prohibited, the modified image frame at least partially based on the encoded image data. For example, the modification manager 160 selectively generates a modified image frame (e.g., the output image frame 186) that is at least partially based on whether image modification is sender permitted or sender prohibited, as described with reference to FIG. 1. The output image frame 186 is at least partially based on the input image frame 122.

The method 1400 thus enables receiving a bitstream 145 that includes the modification indicator 150 indicating whether image modification is sender permitted or sender prohibited and also includes the encoded image data 124 corresponding to the original input image frame 122 without modifications. The device 104 can generate the decoded image frame 172 corresponding to the original input image frame 122 and selectively generate a modified image frame (e.g., the output image frame 186) based at least partially on whether image modification is sender permitted or sender prohibited.

The method 1400 of FIG. 14 may be implemented by a FPGA device, an ASIC, a processing unit such as a CPU, a DSP, a controller, another hardware device, firmware device, or any combination thereof. As an example, the method 1400 of FIG. 14 may be performed by a processor that executes instructions, such as described with reference to FIG. 15.

Referring to FIG. 15, a block diagram of a particular illustrative implementation of a device is depicted and generally designated 1500. In various implementations, the device 1500 may have more or fewer components than illustrated in FIG. 15. In an illustrative implementation, the device 1500 may correspond to the device 102, the device 104, or both. In an illustrative implementation, the device 1500 may perform one or more operations described with reference to FIGS. 1-14.

In a particular implementation, the device 1500 includes a processor 1506 (e.g., a CPU). The device 1500 may include one or more additional processors 1510 (e.g., one or more DSPs). In a particular aspect, the one or more processors 190, the one or more processors 192 of FIG. 1, or a combination thereof, corresponds to the processor 1506, the processors 1510, or a combination thereof. The processors 1510 may include a speech and music coder-decoder (CODEC) 1508 that includes a voice coder (“vocoder”) encoder 1536, a vocoder decoder 1538, or both. The processors 1510 include the image modifier 440. For example, the image modifier 440 includes the modification manager 140, the encoder 142, the bitstream generator 144, the modification manager 160, the decoder 162, the bitstream analyzer 194, or a combination thereof.

The device 1500 may include a memory 1586 and a CODEC 1534. In a particular aspect, the memory 1586 corresponds to the memory 132, the memory 182, or both, of FIG. 1. The memory 1586 may include instructions 1556, that are executable by the one or more additional processors 1510 (or the processor 1506) to implement the functionality described with reference to one or more components of the image modifier 440. The device 1500 may include a modem 1570 coupled, via a transceiver 1550, to an antenna 1552. In a particular aspect, the modem 1570 is configured to receive and transmit data via the transceiver 1550 and the antenna 1552. For example, the modem 1570 is configured to receive a first bitstream 145, transmit a second bitstream 145, or both.

The device 1500 may include a display 1528 coupled to a display controller 1526. In a particular aspect, the display 1528 corresponds to the display device 170, the display device 180 of FIG. 1, or both. One or more speakers 1592, one or more microphones 1590, or a combination thereof, may be coupled to the CODEC 1534. The CODEC 1534 may include a digital-to-analog converter (DAC) 1502, an analog-to-digital converter (ADC) 1504, or both. In a particular implementation, the CODEC 1534 may receive analog signals from the one or more microphones 1590, convert the analog signals to digital signals using the analog-to-digital converter 1504, and provide the digital signals to the speech and music codec 1508. In a particular example, the analog signals may represent user speech corresponding to a voice command to initiate or accept a video call and the image modifier 440 may generate a bitstream 145 or an output image frame 186 responsive to the voice command. The speech and music codec 1508 may process the digital signals. In a particular implementation, the speech and music codec 1508 may provide digital signals to the CODEC 1534. The CODEC 1534 may convert the digital signals to analog signals using the digital-to-analog converter 1502 and may provide the analog signals to the one or more speakers 1592. In a particular aspect, the digital signals may correspond to an audio indicator of whether image modification has been performed and may be provided to the one or more speakers 1592 concurrently with providing the output image frame 186 to the display 1528.

In a particular implementation, the device 1500 may be included in a system-in-package or system-on-chip device 1522. In a particular implementation, the memory 1586, the processor 1506, the processors 1510, the display controller 1526, the CODEC 1534, and the modem 1570 are included in the system-in-package or system-on-chip device 1522. In a particular implementation, an input device 1530 and a power supply 1544 are coupled to the system-in-package or the system-on-chip device 1522. Moreover, in a particular implementation, as illustrated in FIG. 15, the display 1528, the input device 1530, the one or more speakers 1592, the one or more microphones 1590, the antenna 1552, and the power supply 1544 are external to the system-in-package or the system-on-chip device 1522. In a particular implementation, each of the display 1528, the input device 1530, the one or more speakers 1592, the one or more microphones 1590, the antenna 1552, and the power supply 1544 may be coupled to a component of the system-in-package or the system-on-chip device 1522, such as an interface or a controller.

The device 1500 may include a smart speaker, a speaker bar, a mobile communication device, a smart phone, a cellular phone, a laptop computer, a computer, a tablet, a personal digital assistant, a display device, a television, a gaming console, a music player, a radio, a digital video player, a digital video disc (DVD) player, a tuner, a camera, a navigation device, a vehicle, a headset, an augmented reality headset, a mixed reality headset, a virtual reality headset, an aerial vehicle, a home automation system, a voice-activated device, a wireless speaker and voice activated device, a portable electronic device, a car, a computing device, a communication device, an internet-of-things (IoT) device, a virtual reality (VR) device, a base station, a mobile device, or any combination thereof.

In conjunction with the described implementations, an apparatus includes means for obtaining encoded image data representing an image frame of a video. For example, the means for obtaining can correspond to the encoder 142, the bitstream generator 144, the one or more processors 190, the device 102, the system 100 of FIG. 1, the system 200 of FIG. 2, the image modifier 440, the integrated circuit 402 of FIG. 4, the processor 1506, the processor(s) 1510, the antenna 1552, the transceiver 1550, the modem 1570, one or more other circuits or components configured to obtain the encoded image data, or any combination thereof.

The apparatus also includes means for transmitting a bitstream from a sender device to a recipient device during a video communication between the sender device and the recipient device, the bitstream including the encoded image data as part of the video communication and a modification indicator that indicates whether image modification is sender permitted or sender prohibited at the recipient device. For example, the means for transmitting can correspond to the bitstream generator 144, the one or more processors 190, the device 102, the system 100 of FIG. 1, the system 200 of FIG. 2, the image modifier 440, the integrated circuit 402 of FIG. 4, the processor 1506, the processor(s) 1510, the antenna 1552, the transceiver 1550, the modem 1570, one or more other circuits or components configured to transmit the bitstream, or any combination thereof.

Also in conjunction with the described implementations, an apparatus includes means for obtaining, at a recipient device, a modification indicator that indicates whether image modification is sender permitted or sender prohibited, the modification indicator obtained from a bitstream received from a sender device during a video communication between the sender device and the recipient device. The bitstream also includes encoded image data representing an image frame as part of the video communication. For example, the means for obtaining can correspond to the bitstream analyzer 194, the modification manager 160, the one or more processors 192, the device 104, the system 100 of FIG. 1, the system 200 of FIG. 2, the image modifier 440, the integrated circuit 402 of FIG. 4, the processor 1506, the processor(s) 1510, the antenna 1552, the transceiver 1550, the modem 1570, one or more other circuits or components configured to obtain the modification indicator, or any combination thereof.

The apparatus also includes means for selectively generating a modified image frame at least partially based on whether the image modification is sender permitted or sender prohibited, the modified image frame at least partially based on the encoded image data. For example, the means for selectively generating can correspond to the modification manager 160, the one or more processors 192, the device 104, the system 100 of FIG. 1, the system 200 of FIG. 2, the image modifier 440, the integrated circuit 402 of FIG. 4, the processor 1506, the processor(s) 1510, one or more other circuits or components configured to selectively generate the modified image frame, or any combination thereof.

In some implementations, a non-transitory computer-readable medium (e.g., a computer-readable storage device, such as the memory 1586) includes instructions (e.g., the instructions 1556) that, when executed by one or more processors (e.g., the one or more processors 1510 or the processor 1506), cause the one or more processors to obtain, at a sender device (e.g., the device 102), encoded image data (e.g., the encoded image data 124) representing an image frame (e.g., the input image frame 122) of a video. The instructions also cause the one or more processors to send, from the sender device to a recipient device (e.g., the device 104) during a video communication between the sender device and the recipient device, a bitstream (e.g., the bitstream 145) including the encoded image data as part of the video communication and a modification indicator (e.g., the modification indicator 150) that indicates whether image modification is sender permitted or sender prohibited at the recipient device.

Also, in some implementations, a non-transitory computer-readable medium (e.g., a computer-readable storage device, such as the memory 1586) includes instructions (e.g., the instructions 1556) that, when executed by one or more processors (e.g., the one or more processors 1510 or the processor 1506), cause the one or more processors to obtain, at a recipient device (e.g., the device 104), a modification indicator (e.g., the modification indicator 150) that indicates whether image modification is sender permitted or sender prohibited, the modification indicator obtained from a bitstream (e.g., the bitstream 145) received from a sender device (e.g., the device 102) during a video communication between the sender device and the recipient device. The bitstream also includes the encoded image data as part of the video communication. The instructions also cause the one or more processors to selectively generate a modified image frame (e.g., the output image frame 186) at least partially based on whether the image modification is sender permitted or sender prohibited, the modified image frame at least partially based on the encoded image data.

Particular aspects of the disclosure are described below in sets of interrelated Examples:
According to Example 1, a sender device includes a memory configured to store an image frame of a video; and one or more processors coupled to the memory and configured to obtain encoded image data representing the image frame; and send, to a recipient device during a video communication between the sender device and the recipient device, a bitstream including the encoded image data as part of the video communication and a modification indicator that indicates whether image modification is sender permitted or sender prohibited at the recipient device.
Example 2 includes the sender device of Example 1, wherein the bitstream further includes one or more feature indicators that indicate whether one or more modification features associated with the image frame are sender permitted or sender prohibited at the recipient device.
Example 3 includes the sender device of Example 1 or Example 2, wherein the one or more processors are configured to perform facial landmark detection on the image frame to generate facial landmark data, wherein the bitstream includes the facial landmark data.
Example 4 includes the sender device of any of Examples 1 to 3, wherein the one or more processors are configured to, based at least in part on determining that a modification feature is source permitted, selectively send, in the bitstream, a feature indicator indicating that the modification feature is sender permitted.
Example 5 includes the sender device of Example 4, wherein the one or more processors are configured to analyze the image frame to determine whether a modification feature is performable on the image frame; and based on determining that the modification feature is performable on the image frame, selectively send, in the bitstream, the feature indicator indicating that the modification feature is sender permitted.
Example 6 includes the sender device of Example 5, wherein the one or more processors are configured to, based at least in part on determining that the modification feature is performable on the image frame, selectively include corresponding facial landmark data in the bitstream.
Example 7 includes the sender device of any of Examples 1 to 6, wherein the one or more processors are configured to send, in the bitstream, first facial landmark data of a first image frame of the video; determine second facial landmark data of a second image frame of the video; and selectively send, in the bitstream, the second facial landmark data based on detection of a deviation of the second facial landmark data from the first facial landmark data that is greater than threshold deviation.
Example 8 includes the sender device of any of Examples 1 to 7, wherein the one or more processors are configured to selectively send, in the bitstream, facial landmark data of the image frame based on a determination that the image frame corresponds to an intraframe.
Example 9 includes the sender device of any of Examples 1 to 8, and further includes a modem configured to send the bitstream to the recipient device.
Example 10 includes the sender device of any of Examples 1 to 9, and further includes a camera configured to generate the image frame.
Example 11 includes the sender device of any of Examples 1 to 10, and further includes a display device configured to display a graphical user interface (GUI), wherein a value of the modification indicator is based on a user-selectable option of the GUI.
Example 12 includes the sender device of any of Examples 1 to 11, wherein the memory and the one or more processors are integrated in a portable device.
According to Example 13, a method includes obtaining, at a sender device, encoded image data representing an image frame of a video; and sending, from the sender device to a recipient device, a bitstream including the encoded image data as part of the video communication and a modification indicator that indicates whether image modification is sender permitted or sender prohibited at the recipient device.
Example 14 includes the method of Example 13, wherein the bitstream further includes one or more feature indicators that indicate whether one or more modification features associated with the image frame are sender permitted or sender prohibited at the recipient device.
Example 15 includes the method of Example 13 or Example 14, further comprising performing, at the sender device, facial landmark detection on the image frame to generate facial landmark data, wherein the bitstream includes the facial landmark data.
Example 16 includes the method of any of Examples 13 to 15 and further includes, based at least in part on determining that a modification feature is source permitted, selectively sending, in the bitstream, a feature indicator indicating that the modification feature is sender permitted.
Example 17 includes the method of Example 16 and further includes analyzing, at the first device, the image frame to determine whether a modification feature is performable on the image frame; and based on determining that the modification feature is performable on the image frame, selectively sending, in the bitstream, the feature indicator indicating that the modification feature is sender permitted.
Example 18 includes the method of Example 17 and further includes, based at least in part on determining that the modification feature is performable on the image frame, selectively including corresponding facial landmark data in the bitstream.
Example 19 includes the method of any of Examples 13 to 18 and further includes sending, in the bitstream, first facial landmark data of a first image frame of the video; determining, at the first device, second facial landmark data of a second image frame of the video; and selectively sending, in the bitstream, the second facial landmark data based on detection of a deviation of the second facial landmark data from the first facial landmark data that is greater than threshold deviation.
Example 20 includes the method of any of Examples 13 to 19 and further includes selectively sending, in the bitstream, facial landmark data of the image frame based on a determination that the image frame corresponds to an intraframe.
Example 21 includes the method of any of Examples 13 to 20, wherein the bitstream is sent via a modem to the recipient device.
Example 22 includes the method of any of Examples 13 to 21 and further includes receiving the image frame from a camera.
Example 23 includes the method of any of Examples 13 to 22 and further includes providing a graphical user interface (GUI) to a display device, wherein a value of the modification indicator is based on a user-selectable option of the GUI.
According to Example 24, a recipient device includes a memory configured to store encoded image data that represents an image frame of a video; and one or more processors coupled to the memory and configured to obtain a modification indicator that indicates whether image modification is sender permitted or sender prohibited, the modification indicator obtained from a bitstream that is received from a sender device during a video communication between the sender device and the recipient device, where the bitstream also includes the encoded image data as part of the video communication; and selectively generate a modified image frame at least partially based on whether the image modification is sender permitted or sender prohibited, the modified image frame at least partially based on the encoded image data.
Example 25 includes the recipient device of Example 24, wherein the one or more processors are configured to, based on a determination that the modification indicator indicates that image modification is sender permitted, that a feature indicator indicates that a modification feature associated with the image frame is sender permitted, that the modification feature is recipient permitted, and that the modification feature is performable on a decoded image frame, apply the modification feature to the decoded image frame to generate a modified image frame, the decoded image frame based on the encoded image data, wherein the feature indicator is obtained from the received bitstream.
Example 26 includes the recipient device of Example 24 or Example 25,wherein the one or more processors are configured to decode the encoded image data to generate a decoded image frame, the modified image frame based on the decoded image frame.
Example 27 includes the recipient device of Example 26, wherein the one or more processors are configured to perform a modification of the decoded image frame based on facial landmark data to generate the modified image frame.
Example 28 includes the recipient device of Example 27, wherein the facial landmark data is received in the bitstream.
Example 29 includes the recipient device of Example 27 or Example 28,wherein the one or more processors are configured to, based on a determination that a modification feature is sender permitted and that corresponding facial landmark data is not included in the bitstream, generate the facial landmark data.
Example 30 includes the recipient device of any of Examples 26 to 29, wherein the one or more processors are configured to analyze the decoded image frame to determine whether a modification feature is performable on the decoded image frame; and based on determining that the modification feature is sender permitted and that the modification feature is performable on the decoded image frame, apply the modification feature to the decoded image frame to generate the modified image frame.
Example 31 includes the recipient device of any of Examples 26 to 30, wherein the one or more processors are configured to obtain additional image data corresponding to a modification of a portion of the decoded image frame; and generate the modified image frame based on a combination of the additional image data and the decoded image frame.
Example 32 includes the recipient device of Example 31, wherein the one or more processors are configured to, based on determining that a modification feature of the modification is sender permitted, selectively generate the additional image data.
Example 33 includes the recipient device of Example 31, wherein the additional image data is included in the received bitstream.
Example 34 includes the recipient device of any of Examples 24 to 33, wherein the one or more processors are configured to obtain, from the bitstream, first facial landmark data of a first image frame of the video; obtain, from the bitstream, second encoded image data that represents a second image frame of the video; and based on at least in part on determining that second facial landmark data of the second image frame of the video is unavailable in the received bitstream, generate a second modified image frame based on the second encoded image data and the first facial landmark data.
Example 35 includes the recipient device of any of Examples 24 to 34 and further includes a modem configured to receive the bitstream.
Example 36 includes the recipient device of any of Examples 24 to 35 and further includes a display device configured to display the modified image frame.
Example 37 includes the recipient device of any of Examples 24 to 36, wherein the memory and the one or more processors are integrated in a portable device.
According to Example 38, a method includes obtaining, at a recipient device, a modification indicator that indicates whether image modification is sender permitted or sender prohibited, the modification indicator obtained from a bitstream received from a sender device during a video communication between the sender device and the recipient device, where the bitstream also includes encoded image data representing an image frame as part of the video communication; and selectively generating, at the device, a modified image frame at least partially based on whether the image modification is sender permitted or sender prohibited, the modified image frame at least partially based on the encoded image data.
Example 39 includes the method of Example 38, further comprising, based on a determination that the modification indicator indicates that image modification is sender permitted, that a feature indicator indicates that a modification feature is sender permitted, that the modification feature is recipient permitted, and that the modification feature is performable on a decoded image frame, applying the modification feature to the decoded image frame to generate a modified image frame, the decoded image frame based on the encoded image data, wherein the feature indicator is obtained from the received bitstream.
Example 40 includes the method of Example 38 or Example 39, further comprising decoding the encoded image data to generate a decoded image frame, the modified image frame based on the decoded image frame.
Example 41 includes the method of Example 40 and further includes performing a modification of the decoded image frame based on facial landmark data to generate the modified image frame.
Example 42 includes the method of Example 41, wherein the facial landmark data is received in the bitstream.
Example 43 includes the method of Example 41 and further includes, based on determining that a modification feature is sender permitted and that corresponding facial landmark data is not included in the bitstream, generating the facial landmark data.
Example 44 includes the method of any of Examples 40 to 43, further includes analyzing the decoded image frame to determine whether a modification feature is performable on the decoded image frame; and based on determining that the modification feature is sender permitted and that the modification feature is performable on the decoded image frame, applying the modification feature to the decoded image frame to generate the modified image frame.
Example 45 includes the method of any of Examples 40 to 44, further includes obtaining additional image data corresponding to a modification of a portion of the decoded image frame; and generating the modified image frame based on a combination of the additional image data and the decoded image frame.
Example 46 includes the method of Example 45 and further includes, based on determining that a modification feature of the modification is sender permitted, selectively generating the additional image data.
Example 47 includes the method of Example 45 or Example 46, wherein the additional image data is included in the received bitstream.
Example 48 includes the method of any of Examples 38 to 47, further includes obtaining, from the bitstream, first facial landmark data of a first image frame of the video; obtaining, from the bitstream, second encoded image data that represents a second image frame of the video; and based on at least in part on determining that second facial landmark data of the second image frame of the video is unavailable in the received bitstream, generating a second modified image frame based on the second encoded image data and the first facial landmark data.
Example 49 includes the method of any of Examples 38 to 48, wherein the bitstream is received via a modem.
Example 50 includes the method of any of Examples 38 to 49 and further includes providing the modified image frame to a display device.
According to Example 51, a non-transitory computer-readable medium stores instructions that, when executed by one or more processors, cause the one or more processors to obtain, at a sender device, encoded image data representing an image frame of a video; and send, from the sender device to a recipient device during a video communication between the sender device and the recipient device, a bitstream including the encoded image data as part of the video communication and a modification indicator that indicates whether image modification is sender permitted or sender prohibited at the recipient device.
According to Example 52, an apparatus includes means for obtaining encoded image data representing an image frame of a video; and means for transmitting a bitstream from a sender device to a recipient device during a video communication between the sender device and the recipient device, the bitstream including the encoded image data as part of the video communication and a modification indicator that indicates whether image modification is sender permitted or sender prohibited at the recipient device.
According to Example 53, a non-transitory computer-readable medium stores instructions that, when executed by one or more processors, cause the one or more processors to obtain, at a recipient device, a modification indicator that indicates whether image modification is sender permitted or sender prohibited, the modification indicator obtained from a bitstream received from a sender device during a video communication between the sender device and the recipient device, where the bitstream also includes the encoded image data; and selectively generate a modified image frame at least partially based on whether the image modification is sender permitted or sender prohibited, the modified image frame at least partially based on the encoded image data.
According to Example 54, an apparatus includes means for obtaining, at a recipient device, a modification indicator that indicates whether image modification is sender permitted or sender prohibited, the modification indicator obtained from a bitstream received from a sender device during a video communication between the sender device and the recipient device, where the bitstream also includes encoded image data representing an image frame as part of the video communication; and means for selectively generating a modified image frame at least partially based on whether the image modification is sender permitted or sender prohibited, the modified image frame at least partially based on the encoded image data.

Those of skill would further appreciate that the various illustrative logical blocks, configurations, modules, circuits, and algorithm steps described in connection with the implementations disclosed herein may be implemented as electronic hardware, computer software executed by a processor, or combinations of both. Various illustrative components, blocks, configurations, modules, circuits, and steps have been described above generally in terms of their functionality. Whether such functionality is implemented as hardware or processor executable instructions depends upon the particular application and design constraints imposed on the overall system. Skilled artisans may implement the described functionality in varying ways for each particular application, such implementation decisions are not to be interpreted as causing a departure from the scope of the present disclosure.

The steps of a method or algorithm described in connection with the implementations disclosed herein may be embodied directly in hardware, in a software module executed by a processor, or in a combination of the two. A software module may reside in random access memory (RAM), flash memory, read-only memory (ROM), programmable read-only memory (PROM), erasable programmable read-only memory (EPROM), electrically erasable programmable read-only memory (EEPROM), registers, hard disk, a removable disk, a compact disc read-only memory (CD-ROM), or any other form of non-transient storage medium known in the art. An exemplary storage medium is coupled to the processor such that the processor may read information from, and write information to, the storage medium. In the alternative, the storage medium may be integral to the processor. The processor and the storage medium may reside in an application-specific integrated circuit (ASIC). The ASIC may reside in a computing device or a user terminal. In the alternative, the processor and the storage medium may reside as discrete components in a computing device or user terminal.

The previous description of the disclosed aspects is provided to enable a person skilled in the art to make or use the disclosed aspects. Various modifications to these aspects will be readily apparent to those skilled in the art, and the principles defined herein may be applied to other aspects without departing from the scope of the disclosure. Thus, the present disclosure is not intended to be limited to the aspects shown herein but is to be accorded the widest scope possible consistent with the principles and novel features as defined by the following claims.

What is claimed is:

1. A sender device comprising:
a memory configured to store an image frame of a video; and
one or more processors coupled to the memory and configured to:
obtain encoded image data representing the image frame; and
send, to a recipient device during a video communication between the sender device and the recipient device, a bitstream including the encoded image data as part of the video communication and a modification indicator that indicates whether image modification is sender permitted or sender prohibited at the recipient device.

2. The sender device of claim 1, wherein the bitstream further includes one or more feature indicators that indicate whether one or more modification features associated with the image frame are sender permitted or sender prohibited at the recipient device.

3. The sender device of claim 1, wherein the one or more processors are configured to perform facial landmark detection on the image frame to generate facial landmark data, wherein the bitstream includes the facial landmark data.

4. The sender device of claim 1, wherein the one or more processors are configured to, based at least in part on determining that a modification feature is source permitted, selectively send, in the bitstream, a feature indicator indicating that the modification feature is sender permitted.

5. The sender device of claim 4, wherein the one or more processors are configured to:
analyze the image frame to determine whether a modification feature is performable on the image frame; and
based on determining that the modification feature is performable on the image frame, selectively send, in the bitstream, the feature indicator indicating that the modification feature is sender permitted.

6. The sender device of claim 5, wherein the one or more processors are configured to, based at least in part on determining that the modification feature is performable on the image frame, selectively include corresponding facial landmark data in the bitstream.

7. The sender device of claim 1, wherein the one or more processors are configured to:
send, in the bitstream, first facial landmark data of a first image frame of the video;
determine second facial landmark data of a second image frame of the video; and
selectively send, in the bitstream, the second facial landmark data based on detection of a deviation of the second facial landmark data from the first facial landmark data that is greater than threshold deviation.

8. The sender device of claim 1, wherein the one or more processors are configured to selectively send, in the bitstream, facial landmark data of the image frame based on a determination that the image frame corresponds to an intraframe.

9. The sender device of claim 1, further comprising a modem configured to send the bitstream to the recipient device.

10. The sender device of claim 1, further comprising a camera configured to generate the image frame.

11. The sender device of claim 1, further comprising a display device configured to display a graphical user interface (GUI), wherein a value of the modification indicator is based on a user-selectable option of the GUI.

12. The sender device of claim 1, wherein the memory and the one or more processors are integrated in a portable device.

13. A method comprising:
obtaining, at a sender device, encoded image data representing an image frame of a video; and
sending, from the sender device to a recipient device during a video communication between the sender device and the recipient device, a bitstream including the encoded image data as part of the video communication and a modification indicator that indicates whether image modification is sender permitted or sender prohibited at the recipient device.

14. The method of claim 13, wherein the bitstream further includes one or more feature indicators that indicate whether one or more modification features are sender permitted or sender prohibited at the recipient device.

15. A recipient device comprising:
a memory configured to store encoded image data that represents an image frame of a video; and
one or more processors coupled to the memory and configured to:
obtain a modification indicator that indicates whether image modification is sender permitted or sender prohibited, the modification indicator obtained from a bitstream received from a sender device during a video communication between the sender device and the recipient device, wherein the bitstream also includes the encoded image data as part of the video communication; and
selectively generate a modified image frame at least partially based on whether the image modification is sender permitted or sender prohibited, the modified image frame at least partially based on the encoded image data.

16. The recipient device of claim 15, wherein the one or more processors are configured to, based on a determination that the modification indicator indicates that image modification is sender permitted, that a feature indicator indicates that a modification feature associated with the image frame is sender permitted, that the modification feature is recipient permitted, and that the modification feature is performable on a decoded image frame, apply the modification feature to the decoded image frame to generate a modified image frame, the decoded image frame based on the encoded image data, wherein the feature indicator is obtained from the received bitstream.

17. The recipient device of claim 15, wherein the one or more processors are configured to decode the encoded image data to generate a decoded image frame, the modified image frame based on the decoded image frame.

18. The recipient device of claim 17, wherein the one or more processors are configured to perform a modification of the decoded image frame based on facial landmark data to generate the modified image frame.

19. The recipient device of claim 18, wherein the facial landmark data is received in the bitstream.

20. The recipient device of claim 18, wherein the one or more processors are configured to, based on a determination that a modification feature is sender permitted and that corresponding facial landmark data is not included in the bitstream, generate the facial landmark data.

21. The recipient device of claim 17, wherein the one or more processors are configured to:
analyze the decoded image frame to determine whether a modification feature is performable on the decoded image frame; and
based on determining that the modification feature is sender permitted and that the modification feature is performable on the decoded image frame, apply the modification feature to the decoded image frame to generate the modified image frame.

22. The recipient device of claim 17, wherein the one or more processors are configured to:
obtain additional image data corresponding to a modification of a portion of the decoded image frame; and
generate the modified image frame based on a combination of the additional image data and the decoded image frame.

23. The recipient device of claim 22, wherein the one or more processors are configured to, based on determining that a modification feature of the modification is sender permitted, selectively generate the additional image data.

24. The recipient device of claim 22, wherein the additional image data is included in the received bitstream.

25. The recipient device of claim 15, wherein the one or more processors are configured to:
obtain, from the bitstream, first facial landmark data of a first image frame of the video;
obtain, from the bitstream, second encoded image data that represents a second image frame of the video; and
based on at least in part on determining that second facial landmark data of the second image frame of the video is unavailable in the received bitstream, generate a second modified image frame based on the second encoded image data and the first facial landmark data.

26. The recipient device of claim 15, further comprising a modem configured to receive the bitstream.

27. The recipient device of claim 15, further comprising a display device configured to display the modified image frame.

28. The recipient device of claim 15, wherein the memory and the one or more processors are integrated in a portable device.

29. A method comprising:
obtaining, at a recipient device, a modification indicator that indicates whether image modification is sender permitted or sender prohibited, the modification indicator obtained from a bitstream received from a sender device during a video communication between the sender device and the recipient device, wherein the bitstream also includes encoded image data representing an image frame as part of the video communication; and
selectively generating, at the device, a modified image frame at least partially based on whether the image modification is sender permitted or sender prohibited, the modified image frame at least partially based on the encoded image data.

30. The method of claim 29, further comprising, based on a determination that the modification indicator indicates that image modification is sender permitted, that a feature indicator indicates that a modification feature is sender permitted, that the modification feature is recipient permitted, and that the modification feature is performable on a decoded image frame, applying the modification feature to the decoded image frame to generate a modified image frame, the decoded image frame based on the encoded image data, wherein the feature indicator is obtained from the received bitstream.
